(19) United States
(12) Patent Application Publication
(10) Pub. No.: US 2026/0269486 A1
(43) Pub. Date: Sep. 10, 2026

(54) ELECTRONIC DEVICE

(71) Applicant: Honor Device Co., Ltd., Shenzhen (CN)

(72) Inventors: Ning Ma, Shenzhen (CN); Guolong Wang, Shenzhen (CN); Xiaotao Cai, Shenzhen (CN); Chao Feng, Shenzhen (CN); Dawei Zhou, Shenzhen (CN)

(21) Appl. No.: 19/657,918

(22) Filed: Apr. 24, 2026

Related U.S. Application Data
(63) Continuation of application No. PCT/CN2023/142156, filed on Dec. 26, 2023.

(51) Int. Cl. H01Q 15/24; H01Q 1/24; H01Q 1/36; H01Q 1/48; H01Q 9/02

(52) U.S. Cl. CPC H01Q 15/24; H01Q 1/243; H01Q 1/36; H01Q 1/48; H01Q 9/02

(57) ABSTRACT

This application relates to the antenna field, and provides an electronic device. The electronic device includes an antenna structure. The antenna structure includes two radiators that are mutually non-contacting. A first radiator is disposed on a side of a ground plane (for example, a part of a bezel may be formed as the first radiator). A second radiator is disposed above and parallel to the ground plane. The antenna structure is fed by using a feed point disposed on at least one radiator, so that the two radiators perform energy coupling to radiate an electromagnetic wave. In addition, the antenna structure can generate electric field components in two directions (for example, an x-direction and a z-direction) that are perpendicular to each other.

### CROSS-REFERENCE TO RELATED APPLICATIONS

This application is a continuation of International Application No. PCT/CN2023/142156, filed on Dec. 26, 2023. The disclosure of the aforementioned application is hereby incorporated by reference in its entirety.

### TECHNICAL FIELD

This application relates to the antenna field, and more specifically, to an electronic device installed with an antenna.

### BACKGROUND

With rapid development of wireless communication technologies, antennas, as essential components in various wireless communication devices, have achieved widespread application and significant technological advancements. Circular polarization is a form of electromagnetic wave polarization, and electromagnetic waves that are circularly polarized are termed circularly polarized waves. Antennas (circularly polarized antennas for short) that radiate circularly polarized waves have advantages such as receiving incoming linearly polarized waves, reducing impact of reflected signals, and having good penetration performance. Therefore, the circularly polarized antennas have important applications in aspects such as communication, radar, electronic countermeasures, electronic reconnaissance, and broadcasting and television.

Currently, the rise of satellite communication accelerates development of the circularly polarized antennas. For a handheld electronic device such as a mobile phone, a miniature design of an antenna is required. A mobile phone is used as an example. An antenna may be formed by using a part of a bezel of the mobile phone. However, the antenna with such a structure has poor circular polarization performance, resulting in poor user experience.

### SUMMARY

Embodiments of this application provide an electronic device, so that circular polarization performance of an antenna structure configured in the electronic device can be enhanced, thereby improving user experience.

The electronic device includes a ground plane and a first antenna structure, where the first antenna structure includes a first radiator and a second radiator. The first radiator is disposed on a side of the ground plane, and a first gap is spaced between the first radiator and the ground plane. The second radiator is disposed above and parallel to the ground plane, and a second gap is spaced between the second radiator and the ground plane. The first radiator and the second radiator are mutually non-contacting. At least one of the first radiator and the second radiator is provided with at least one feed point, where when feeding is performed at the feed point, the first radiator and the second radiator operate at a same operating frequency, and the first antenna structure is capable of generating an electric field component distributed along a first direction and an electric field component distributed along a second direction, where the first direction is perpendicular to the second direction, the first direction is parallel to a length direction of the first radiator, and the second direction is perpendicular to a plane in which the ground plane is located.

In embodiments of this application, the first radiator is disposed on a side of the ground plane, and the second radiator is disposed above and parallel to the ground plane. The first antenna structure is fed by using the feed point disposed on at least one radiator, so that the first radiator and the second radiator can perform energy coupling to radiate an electromagnetic wave, and an electric field component distributed along the first direction (for example, an x-direction) and an electric field component distributed along the second direction (for example, a z-direction) can be generated. A propagation direction of the first antenna structure is approximately parallel to a third direction (for example, a y-direction). For example, the propagation direction is a positive y-direction. Because the second radiator disposed above the ground plane is added, the second radiator can provide additional electric field components in the second direction (for example, the z-direction) perpendicular to the plane in which the ground plane is located, so that electric field components of the second radiator in the second direction (for example, the z-direction) are increased. In addition, the first radiator itself can provide sufficient electric field components in the first direction (for example, the x-direction). In this way, on a plane (for example, an xz plane) perpendicular to a propagation direction of the electromagnetic waves, two perpendicular and orthogonal electric field components (for example, an electric field component in the x-direction and an electric field component in the y-direction) can be desirably formed. This facilitates formation of a circularly polarized wave, thereby improving circular polarization performance of the first antenna structure.

In the foregoing embodiment, the first radiator is capable of generating the electric field component distributed along the first direction, and the second radiator is capable of generating the electric field component distributed along the second direction.

It should be understood that the first radiator is mainly configured to generate the electric field component distributed along the first direction, and the second radiator mainly configured to generate the electric field component distributed along the second direction. During implementation, the first radiator may further generate a small quantity of electric field components distributed along the second direction. However, compared with electric field components distributed along the second direction and generated by the second radiator, the electric field components distributed along the second direction and generated by the first radiator are much less.

In some embodiments, the electronic device includes a bezel, the bezel surrounds the ground plane, and the first radiator is a part of the bezel.

In some embodiments, the second radiator is formed by using a laser direct structuring technology, a flexible printed circuit technology, or a floating metal technology. For example, the second radiator is formed as a sheet-like structure.

In some embodiments, the ground plane is a printed circuit board or a mid-frame in the electronic device.

In some embodiments, at least one of the first radiator and the second radiator is provided with a plurality of feed points.

In some other embodiments, one of the first radiator and the second radiator is provided with the feed point.

In other words, the first radiator or the second radiator is provided with the feed point.

In embodiments of this application, the first radiator or the second radiator is provided with one feed point, to implement a structure in which one feed point is disposed in the first antenna structure. This design is simple and convenient to implement.

In the embodiment in which one of the first radiator and the second radiator is provided with one feed point, in some embodiments, the feed point is disposed in proximity to the other radiator that is not provided with a feed point.

In an example, the feed point is disposed on the second radiator and is positioned proximate to the first radiator. In another example, the feed point is disposed on the first radiator and is positioned proximate to the second radiator.

In embodiments of this application, the two radiators are mutually non-contacting. An electromagnetic wave is radiated through energy coupling, and the feed point is disposed in proximity to the other radiator that is not provided with a feed point, so that an energy loss can be reduced, and coupling performance of the first antenna structure can be improved.

In the embodiment in which one of the first radiator and the second radiator is provided with one feed point, in some embodiments, one end, distributed along the first direction, of one of the first radiator and the second radiator is provided with the feed point.

In an example, either of two ends of the second radiator that are distributed along the first direction (for example, the x-direction) is provided with the feed point.

In another example, either of two ends of the first radiator that are distributed along the first direction (for example, the x-direction) is provided with the feed point.

In embodiments of this application, such a structure in which the feed point is disposed at an end portion of the radiator helps form a left-handed circularly polarized wave or a right-handed circularly polarized wave.

In the embodiment in which one of the first radiator and the second radiator is provided with one feed point, in some embodiments, the second radiator is provided with the feed point.

In embodiments of this application, the second radiator is a newly added radiator, for a purpose of providing additional electric field components in the second direction (for example, the z-direction) perpendicular to a plane (for example, an xy plane) in which the ground plane is located. The feed point is disposed on the second radiator, so that the second radiator is more fully excited, and more electric field components can be provided in the second direction (for example, the z-direction). In addition, in an embodiment in which the first radiator is a part of a metal bezel of the electronic device, because parts such as a display screen and a receiver around the bezel affect performance of the first radiator, disposing the feed point on the second radiator can reduce impact of these components on the first antenna structure to some extent.

In the embodiment in which the second radiator is provided with the feed point, in some embodiments, a matching circuit that is grounded is disposed on the first radiator, and the matching circuit is configured to match an operating frequency of the first antenna structure.

In embodiments of this application, the first radiator is matched to the operating frequency of the first antenna structure by using the matching circuit, so that the first antenna structure can achieve good performance at the operating frequency. In addition, left-handed circularly polarized components or right-handed circularly polarized components may be controlled.

In the embodiment in which the matching circuit that is grounded is disposed on the first radiator, in some embodiments, one end, distributed along the first direction, of the first radiator is provided with a first port; the matching circuit includes a first matching circuit that is grounded; the first matching circuit is disposed at the first port; the first port and the feed point are located on a same side of the first antenna structure; and the first matching circuit includes a capacitor.

In an example, a first end, distributed along the first direction, of the first radiator is provided with the first port; a first end, distributed along the first direction, of the second radiator is provided with the feed point; and the first end, distributed along the first direction, of the first radiator and the first end, distributed along the first direction, of the second radiator are located on a same side of the first antenna structure. In this way, the first port and the feed point are located on a same side of the first antenna structure.

In another example, a second end, distributed along the first direction, of the first radiator is provided with the first port; a second end, distributed along the first direction, of the second radiator is provided with the feed point; and the second end, distributed along the first direction, of the first radiator and the second end, distributed along the first direction, of the second radiator are located on a same side of the first antenna structure. In this way, the first port and the feed point are located on a same side of the first antenna structure.

In embodiments of this application, the capacitor itself can be configured to adjust phase lead or lag. From a perspective of enhancing the circular polarization performance (left-handed circular polarization performance or right-handed circular polarization performance) of the first antenna structure, the first port is disposed at one end of the first radiator and the second port is disposed at the other end of the first radiator, the first matching circuit at the first port includes the capacitor, and the feed point and the capacitor at the first port are located on a same side of the first antenna structure. In some scenarios, a phase difference between two perpendicular and orthogonal electric field components (for example, electric field components distributed along the x-direction and the z-direction) generated by the first antenna structure can approximate to a requirement for a circular polarization phase difference (±90°). In this way, a left-handed circularly polarized component or a right-handed circularly polarized component of the first antenna structure can be well controlled while the first matching circuit can match the operating frequency of the first antenna structure, thereby facilitating formation of a circularly polarized wave of the first antenna structure, obtaining good circular polarization directivity, and improving circular polarization performance of the first antenna structure.

In the embodiment in which the first matching circuit is disposed at the first port of the first radiator, in some embodiments, the other end, distributed along the first direction, of the first radiator is provided with the second port. The matching circuit further includes a second matching circuit that is grounded; the second matching circuit is disposed at the second port; and the second matching circuit includes an inductor.

In an example, the first end, distributed along the first direction, of the first radiator is provided with the first port, and the second end, distributed along the first direction, of the first radiator is provided with the second port.

In another example, the second end, distributed along the first direction, of the first radiator is provided with the first port; and the first end, distributed along the first direction, of the first radiator is provided with the second port.

In embodiments of this application, the capacitor and the inductor themselves can be configured to adjust phase lead or lag. The first port is disposed at one end of the first radiator and the second port is disposed at the other end of the first radiator, the first matching circuit at the first port includes the capacitor, the second matching circuit at the second port includes the inductor, and the feed point and the capacitor at the first port are located on a same side of the first antenna structure. Therefore, a phase difference between two perpendicular and orthogonal electric field components (for example, electric field components distributed along the x-direction and the z-direction) generated by the first antenna structure can more approximate to a requirement for a circular polarization phase difference (±90°). In this way, a left-handed circularly polarized component or a right-handed circularly polarized component of the first antenna structure can be well controlled while the first matching circuit can match the operating frequency of the first antenna structure, thereby facilitating formation of a circularly polarized wave of the first antenna structure, obtaining good circular polarization directivity, and improving circular polarization performance of the first antenna structure.

In some embodiments, a third matching circuit is disposed at the feed point, and the third matching circuit is configured to match the operating frequency of the first antenna structure.

In embodiments of this application, the second radiator is matched to the operating frequency of the first antenna structure by using the third matching circuit, so that the first antenna structure can achieve good performance at the operating frequency.

In some embodiments, two ends of the second radiator that are distributed along the first direction are respectively flush with two ends of the first radiator that are distributed along the first direction.

In embodiments of this application, the two ends of the first radiator that are distributed along the first direction (for example, the x-direction) are respectively flush with the two ends of the second radiator that are distributed along the first direction (for example, the x-direction), which means that electrical lengths (or physical lengths) of the two radiators along the first direction (for example, the x-direction) are basically the same. This disposing manner increases an area for energy coupling between the two radiators, so that energy coupling between the two radiators is better.

In some embodiments, one end, distributed along the first direction, of the second radiator is not flush with respect to one end of the first radiator on a same side, and the other end, distributed along the first direction, of the second radiator is flush or not flush with the other end of the first radiator on a same side.

In the foregoing embodiment, for example, one end, distributed along the first direction, of the second radiator retracts relative to one end of the first radiator on a same side, and an electronic component is disposed on a side of the end, distributed along the first direction, of the second radiator.

In embodiments of this application, if the electronic component is disposed on a side of the end, distributed along the first direction, of the second radiator, the end, distributed along the first direction, of the second radiator retracts relative to the end of the first radiator on the same side, to avoid the electronic component, provide a clean operating environment for the second radiator, and reduce impact of the electronic component on performance of the first antenna structure.

For example, the electronic component is a receiver.

In some embodiments, an electrical length of the second radiator along the first direction and an electrical length of the first radiator along the first direction are both between a one-quarter wavelength and a one-half wavelength, where the wavelength is an operating wavelength of the first antenna structure.

In some embodiments, projections of the first radiator and the second radiator on a plane formed by the first direction and the second direction at least partially overlap. In this way, energy coupling between the first radiator and the second radiator can be desirably implemented.

In some embodiments, the electronic device further includes a second antenna structure, and an operating frequency of the second antenna structure is different from the operating frequency of the first antenna structure. The second antenna structure includes a third radiator, where the third radiator is disposed on a side of the first radiator, the third radiator is provided with a third port, and a fourth matching circuit is disposed at the third port, and is configured to match the third radiator to the operating frequency of the first antenna structure.

For example, the second antenna structure is configured for WIFI communication.

In this embodiment of this application, the first antenna structure and the second antenna structure operate in a time-division manner. When the first antenna structure operates, the second antenna structure stops operating. The third radiator of the second antenna structure is provided with the fourth matching circuit that is configured to match the third radiator to the operating frequency of the first antenna structure. When the first antenna structure operates, the third radiator may be used as a part of the first antenna structure, so that the third radiator operates at the operating frequency of the first antenna structure. That is, the third radiator, the first radiator, and the second radiator operate as a whole, to reduce impact of the third radiator on the first antenna structure as much as possible.

In the foregoing embodiment in which the electronic device includes the second antenna structure, the electronic device further includes a third antenna structure, and an operating frequency of the third antenna structure is different from both the operating frequency of the first antenna structure and the operating frequency of the second antenna structure, where the third antenna structure includes a fourth radiator, the fourth radiator is disposed on the other side of the first radiator, the fourth radiator is provided with a fourth port, and a fifth matching circuit is disposed at the fourth port, and is configured to match the fourth radiator to the operating frequency of the first antenna structure.

For example, the third antenna structure may be configured for LTE communication and/or NR communication.

In embodiments of this application, the first antenna structure, the second antenna structure, and the third antenna structure operate in a time-division manner. When the first antenna structure operates, both the second antenna structure and the third antenna structure stop operating. The fourth radiator of the third antenna structure is provided with the fifth matching circuit that is configured to match the fourth radiator to the operating frequency of the first antenna structure. Based on the fourth matching circuit that is configured to match the third radiator to the operating frequency of the first antenna structure and that is disposed on the third radiator of the second antenna structure, when the first antenna structure operates, the third radiator and the fourth radiator may be used as a part of the first antenna structure, so that the third radiator and the fourth radiator operate at the operating frequency of the first antenna structure. That is, the third radiator, the fourth radiator, the first radiator, and the second radiator operate as a whole, to reduce impact of the third radiator and the fourth radiator on the first antenna structure as much as possible.

In some embodiments, the first antenna structure further includes an antenna holder, the second radiator is disposed on the antenna holder, and the antenna holder is disposed on the ground plane.

In embodiments of this application, the second radiator is disposed on the ground plane by using the antenna holder, to support the second radiator.

In some embodiments, the first gap (323) is less than or equal to 2 mm, and/or the second gap (324) is less than or equal to 3 mm.

Size ranges of the first gap and/or the second gap are very applicable to a lightweight handheld device such as a mobile phone, a tablet computer, or a notebook computer.

In some embodiments, the first antenna structure is disposed on a top end of the electronic device.

In embodiments of this application, the first antenna structure is disposed on the top end of the electronic device. When a user holds the electronic device in a normal manner, the first antenna structure located on the top end of the electronic device is less likely to be blocked by a hand. This can avoid additional impact on the performance of the first antenna structure.

In some embodiments, a rear camera is disposed at the top end of the electronic device, and the second radiator is disposed between the first radiator and the rear camera.

In some embodiments, the first antenna structure is configured for satellite communication.

### BRIEF DESCRIPTION OF THE DRAWINGS

FIG. 1 is a schematic diagram of a plurality of polarization forms of an electromagnetic wave according to an embodiment of this application;

FIG. 2 is a schematic diagram of an elliptically polarized wave according to an embodiment of this application;

FIG. 3 is a schematic structural diagram of an electronic device according to an embodiment of this application;

FIG. 4 is a schematic diagram of an electronic device with a rear cover removed according to an embodiment of this application;

FIG. 5 is a current distribution diagram of a local region near an antenna structure in the electronic device shown in FIG. 4, when an operating frequency of a prior-art antenna structure is 2.2 Ghz;

FIG. 6 is a distribution diagram of an electric field in a local region near an antenna structure in the electronic device shown in FIG. 4, when an operating frequency of a prior-art antenna structure is 2.2 Ghz;

FIG. 7 is a diagram of left-handed circular polarization directivity of the electronic device shown in FIG. 4, when an operating frequency of a prior-art antenna structure is 2.2 Ghz;

FIG. 8 is a diagram of left-handed circular polarization directivity of the electronic device shown in FIG. 4, when an operating frequency of a prior-art antenna structure is 2.0 Ghz;

FIG. 9 is a schematic diagram of a local region near a first antenna structure in an electronic device according to an embodiment of this application;

FIG. 10 is a three-dimensional schematic diagram of a local region near a first antenna structure in an electronic device according to an embodiment of this application;

FIG. 11 is a cross-sectional view of an electronic device configured with a first antenna structure according to an embodiment of this application;

FIG. 12 is another cross-sectional view of an electronic device configured with a first antenna structure according to an embodiment of this application;

FIG. 13 is another cross-sectional view of an electronic device configured with a first antenna structure according to an embodiment of this application;

FIG. 14 is another schematic diagram of a local region near a first antenna structure in an electronic device according to an embodiment of this application;

FIG. 15 is a schematic diagram of projections of a first radiator and a second radiator on a projection plane according to an embodiment of this application;

FIG. 16 is another schematic diagram of a local region near a first antenna structure in an electronic device according to an embodiment of this application;

FIG. 17 is another schematic diagram of a local region near a first antenna structure in an electronic device according to an embodiment of this application;

FIG. 18 is a schematic diagram of a matching circuit according to an embodiment of this application;

FIG. 19 is another schematic diagram of a matching circuit according to an embodiment of this application;

FIG. 20 is another schematic diagram of a local region near a first antenna structure in an electronic device according to an embodiment of this application;

FIG. 21 is a current distribution diagram of a local region near a first antenna structure in the electronic device shown in FIG. 20, when an operating frequency of the first antenna structure is 2.2 Ghz according to an embodiment of this application;

FIG. 22 is a distribution diagram of an electric field in a local region near a first antenna structure in the electronic device shown in FIG. 20, when an operating frequency of the first antenna structure is 2.2 Ghz according to an embodiment of this application;

FIG. 23 is a diagram of left-handed circular polarization directivity of the electronic device shown in FIG. 20, when an operating frequency of a first antenna structure is 2.2 Ghz according to an embodiment of this application;

FIG. 24 is a diagram of left-handed circular polarization directivity of the electronic device shown in FIG. 20, when an operating frequency of a first antenna structure is 2.0 Ghz according to an embodiment of this application;

FIG. 25 is another schematic diagram of a local region near a first antenna structure in an electronic device according to an embodiment of this application;

FIG. 26 is another three-dimensional schematic diagram of a local region near a first antenna structure in an electronic device according to an embodiment of this application;

FIG. 27 is another schematic diagram of a local region near a first antenna structure in an electronic device according to an embodiment of this application;

FIG. 28 is another schematic diagram of a local region near a first antenna structure in an electronic device according to an embodiment of this application;

FIG. 29 is another three-dimensional schematic diagram of a local region near a first antenna structure in an electronic device according to an embodiment of this application;

FIG. 30 is a current distribution diagram of a local region near a first antenna structure in the electronic device shown in FIG. 29, when an operating frequency of the first antenna structure is 2.2 Ghz according to an embodiment of this application;

FIG. 31 is a distribution diagram of an electric field in a local region near a first antenna structure in the electronic device shown in FIG. 29, when an operating frequency of the first antenna structure is 2.2 Ghz according to an embodiment of this application;

FIG. 32 is a diagram of right-handed circular polarization directivity of the electronic device shown in FIG. 29, when an operating frequency of a first antenna structure is 2.2 Ghz according to an embodiment of this application;

FIG. 33 is a diagram of right-handed circular polarization directivity of the electronic device shown in FIG. 29, when an operating frequency of a first antenna structure is 2.0 Ghz according to an embodiment of this application;

FIG. 34 is another schematic diagram of a local region near a first antenna structure in an electronic device according to an embodiment of this application;

FIG. 35 is another three-dimensional schematic diagram of a local region near a first antenna structure in an electronic device according to an embodiment of this application;

FIG. 36 is another schematic diagram of a local region near a first antenna structure in an electronic device according to an embodiment of this application;

FIG. 37 is another schematic diagram of a local region near a first antenna structure in an electronic device according to an embodiment of this application;

FIG. 38 is another schematic diagram of a matching circuit according to an embodiment of this application;

FIG. 39 is another three-dimensional schematic diagram of a local region near a first antenna structure in an electronic device according to an embodiment of this application;

FIG. 40 is a current distribution diagram of a local region near a first antenna structure in the electronic device shown in FIG. 39, when an operating frequency of the first antenna structure is 2.2 Ghz according to an embodiment of this application;

FIG. 41 is a distribution diagram of an electric field in a local region near a first antenna structure in the electronic device shown in FIG. 39, when an operating frequency of the first antenna structure is 2.2 Ghz according to an embodiment of this application;

FIG. 42 is a diagram of left-handed circular polarization directivity of the electronic device shown in FIG. 39, when an operating frequency of a first antenna structure is 2.2 Ghz according to an embodiment of this application;

FIG. 43 is a diagram of left-handed circular polarization directivity of the electronic device shown in FIG. 39, when an operating frequency of a first antenna structure is 2.0 Ghz according to an embodiment of this application;

FIG. 44 is another schematic diagram of a local region near a first antenna structure in an electronic device according to an embodiment of this application;

FIG. 45 is another three-dimensional schematic diagram of a local region near a first antenna structure in an electronic device according to an embodiment of this application;

FIG. 46 is another schematic diagram of a local region near a first antenna structure in an electronic device according to an embodiment of this application;

FIG. 47 is another schematic diagram of a local region near a first antenna structure in an electronic device according to an embodiment of this application;

FIG. 48 is another three-dimensional schematic diagram of a local region near a first antenna structure in an electronic device according to an embodiment of this application;

FIG. 49 is a current distribution diagram of a local region near a first antenna structure in the electronic device shown in FIG. 48, when an operating frequency of the first antenna structure is 2.2 Ghz according to an embodiment of this application;

FIG. 50 is a distribution diagram of an electric field in a local region near a first antenna structure in the electronic device shown in FIG. 49, when an operating frequency of the first antenna structure is 2.2 Ghz according to an embodiment of this application;

FIG. 51 is a diagram of right-handed circular polarization directivity of the electronic device shown in FIG. 49, when an operating frequency of a first antenna structure is 2.2 Ghz according to an embodiment of this application;

FIG. 52 is a diagram of right-handed circular polarization directivity of the electronic device shown in FIG. 49, when an operating frequency of a first antenna structure is 2.0 Ghz according to an embodiment of this application; and

FIG. 53 is still another schematic diagram of a local region near a first antenna structure in an electronic device according to an embodiment of this application.

### DETAILED DESCRIPTION OF THE ILLUSTRATIVE EMBODIMENTS

The following describes technical solutions of this application with reference to the accompanying drawings.

It should be understood that, in embodiments of this application, unless otherwise explicitly specified or defined, terms “connect”, “interconnect”, and “electrically connect” should be understood in a broad sense. A person of ordinary skill in the art may understand specific meanings of the various foregoing terms in embodiments of this application according to a specific situation.

Both “connect” and “interconnect” may refer to a mechanical or physical connection relationship. To be specific, “A is connected to B” or “A is interconnected with B” may indicate that there is a fastening member (for example, a screw, a bolt, or a rivet) between A and B, or that A and B are in contact with each other and are difficult to separate.

“Electrically connect” may be understood as that components are in physical contact and electrically conducted, and may also be understood as a form in a circuit configuration in which different components are connected through a physical pathway capable of transmitting an electrical signal, such as a printed circuit board (printed circuit board, PCB) copper trace or wire.

It should be further understood that “parallel” or “perpendicular” described in embodiments of this application may be understood as “approximately parallel” or “approximately perpendicular”.

It should be further understood that terms “first” and “second” are merely used for description purposes, and shall not be understood as indicating or implying relative importance or implicitly indicating a quantity of indicated technical features. Therefore, a feature defined with “first” or “second” may explicitly or implicitly include one or more features.

In embodiments of this application, unless otherwise explicitly specified and defined, a first feature “on” or “under” a second feature may mean that the first feature and the second feature are in direct contact, or the first feature and the second feature are in indirect contact through an intermediary. In addition, that the first feature is “above”, “over”, or “on” the second feature may be that the first feature is directly above or obliquely above the second feature, or may merely indicate that the horizontal position of the first feature is higher than the horizontal position of the second feature. That the first feature is “below”, “under”, or “beneath” the second feature may be that the first feature is directly below or obliquely below the second feature, or may merely indicate that the horizontal position of the first feature is lower than the horizontal position of the second feature.

It should be further understood that an orientation or a position relationship (if any) indicated by terms such as “inside”, “outside”, “above”, “front”, or “rear” is an orientation or a position relationship shown in the accompanying drawings, and is merely for ease and brevity of description of this application, rather than indicating or implying that mentioned apparatuses or elements need to have specific orientations or need to be constructed or manipulated according to specific orientations, and therefore shall not be construed as any limitation on this application.

In embodiments of this application, “at least one” means one or more, and “a plurality of” means two or more. “At least a part of an element” refers to a part or all of the element. “And/or” describes an association relationship for associated objects and represents that three relationships may exist. For example, A and/or B may represent: only A exists, both A and B exist, and only B exists, where A and B may be singular or plural. A character “/” usually indicates an “or” relationship between associated objects.

It should be noted that, in embodiments of this application, a same reference number is used to represent a same component or a same part. For a same part in embodiments of this application, a reference number may be marked by using only one of components or parts as an example in the accompany drawings. It should be understood that, for other same components or parts, the reference number is also applicable.

Technical solutions in embodiments of this application relate to the antenna field, and are used to design an antenna structure, to improve circular polarization performance of the antenna structure. The antenna structure may be well used in satellite communication, but is not limited to satellite communication, and may also be used in another communication technology, provided that the circular polarization performance of the antenna structure can be improved. For example, in addition to satellite communication, the technical solutions in embodiments of this application may further be applied to: a Bluetooth (blue tooth, BT) communication technology, a wireless fidelity (wireless fidelity, WiFi) communication technology, a long term evolution (long term evolution, LTE) communication technology, a 5G communication technology, a 6G communication technology, other future communication technologies, and the like.

For ease of understanding, related terminologies of an antenna in embodiments of this application are first described.

### Polarization and Circular Polarization of an Electromagnetic Wave

Polarization of an electromagnetic wave refers to a trajectory traced over time by an electromagnetic wave at a given position in space. The polarization of the electromagnetic wave is mainly classified into linear polarization, circular polarization, and elliptical polarization, where the circular polarization and the linear polarization may be regarded as two special forms of the elliptical polarization.

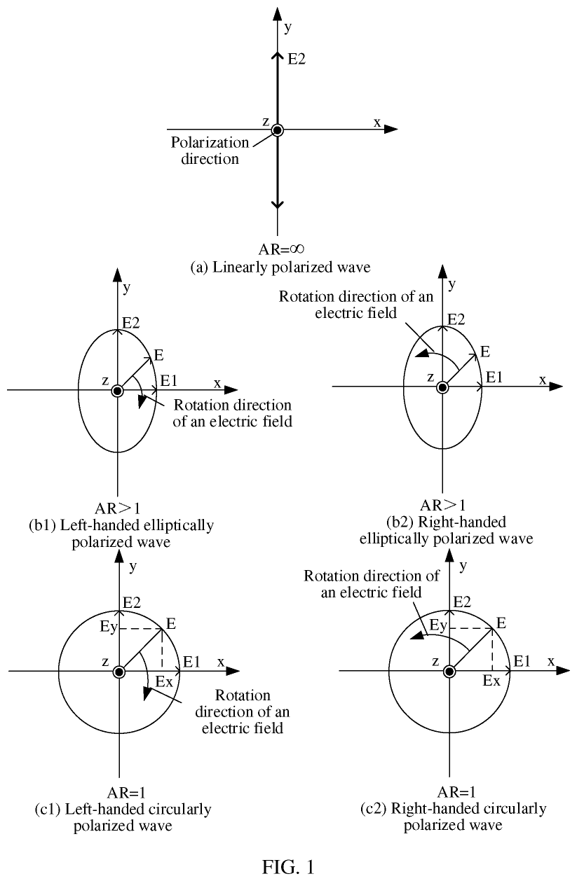

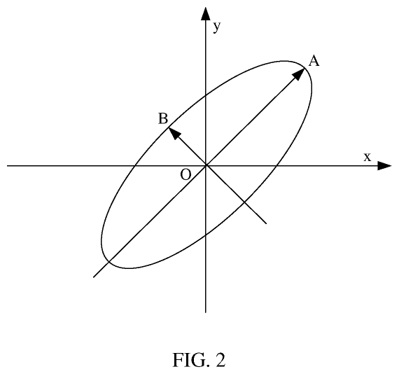

FIG. 1 is a schematic diagram of a plurality of polarization forms of an electromagnetic wave according to an embodiment of this application. (a) in FIG. 1 is a schematic diagram of a linearly polarized wave, (b1) and (b2) in FIG. 1 respectively show a left-handed elliptically polarized wave and a right-handed elliptically polarized wave, and (c1) and (c2) in FIG. 1 respectively show a left-handed circularly polarized wave and a right-handed circularly polarized wave. FIG. 2 is a schematic diagram of an elliptically polarized wave according to an embodiment of this application.

Linear polarization: When an electric field vector oscillates back and forth along a straight line, it is referred to as linear polarization of a wave, as shown in (a) of FIG. 1. Elliptical polarization: When a magnitude of an electric field vector varies with time and a trajectory of a tip of the electric field vector along a direction of rotation is an ellipse, this elliptical trajectory is referred to as elliptical polarization. The elliptical polarization is classified into left-handed elliptical polarization and right-handed elliptical polarization. A method for determining the left-handed elliptical polarization and the right-handed elliptical polarization may be described as follows: The thumb of the left hand is pointed to a direction of wave propagation, and the rest four fingers are aligned with a rotation direction of an electric field. If this conforms to a left-handed rule, it is termed left-handed elliptical polarization. Conversely, the thumb of the right hand is pointed to a direction of wave propagation, and the rest four fingers are aligned with a rotation direction of an electric field. If this conforms to a right-handed rule, it is termed right-handed elliptical polarization. In addition, an elliptically polarized electromagnetic wave is referred to as an elliptically polarized wave, and is divided into a left-handed elliptically polarized wave and a right-handed elliptically polarized wave.

Refer to (b1) in FIG. 1. A propagation direction of a wave is outward relative to a paper plane, a rotation direction of an electric field is a clockwise direction, and the propagation direction of the wave and the rotation direction of the electric field conform to the left-handed rule. Therefore, the wave shown in (b1) in the figure is a left-handed elliptically polarized wave. Refer to (b2) in FIG. 1. A propagation direction of a wave is outward relative to a paper plane, a rotation direction of an electric field is a counterclockwise direction, and the propagation direction of the wave and the rotation direction of the electric field conform to the right-handed rule. Therefore, the wave shown in (b2) in the figure is a right-handed elliptically polarized wave. In (b1) and (b2) in FIG. 1, E is an electric field vector, and represents an amplitude of a total linearly polarized wave, E1 represents an amplitude of a linearly polarized wave along an x-direction, and E2 represents an amplitude of a linearly polarized wave along a y-direction. For an elliptically polarized wave, E1 is not equal to E2.

Circular polarization: A magnitude of an electric field vector remains constant, and its tip undergoes circular motion. An electromagnetic wave exhibiting such circular motion may be referred to as a circularly polarized electromagnetic wave. The circular polarization is classified into left-handed circular polarization and right-handed circular polarization. A manner of determining the left-handed circular polarization and the right-handed circular polarization is the same as that of determining the left-handed elliptical polarization and the right-handed elliptical polarization. Details are not described again. In addition, a circularly polarized electromagnetic wave is referred to as a circularly polarized wave, and is divided into a left-handed circularly polarized wave and a right-handed elliptical polarized wave.

Refer to (c1) in FIG. 1. A propagation direction of a wave is outward relative to a paper plane, a rotation direction of an electric field is a clockwise direction, and the propagation direction of the wave and the rotation direction of the electric field conform to the left-handed rule. Therefore, the wave shown in (c1) in the figure is a left-handed circularly polarized wave. Refer to (c2) in FIG. 1. A propagation direction of a wave is outward relative to a paper plane, a rotation direction of an electric field is a counterclockwise direction, and the propagation direction of the wave and the rotation direction of the electric field conform to the right-handed rule. Therefore, the wave shown in (c2) in the figure is a right-handed circularly polarized wave. E1 is equal to E2 for a circularly polarized wave.

For the elliptical polarization or the circular polarization, from another perspective, if there exist two perpendicular and orthogonal electric field components (for example, an electric field component Ex in the x-direction and an electric field component Ey in the y-direction) in a plane (for example, an xy plane) perpendicular to a wave propagation direction (for example, a z-direction), and a phase difference between the two electric field components is 90 degrees, a wave in a form of elliptical polarization or circular polarization along the propagation direction may be formed. For circular polarization, amplitudes of linearly polarized waves along two directions that are perpendicular to each other and that are in a plane perpendicular to a wave propagation direction are the same, that is, E1=E2. For elliptical polarization, E1 is not equal to E2. The circular polarization is used as an example. In the left-handed circularly polarized wave shown in (c1) in FIG. 1, E1=E2, and the electric field component Ey in the y-direction lags the electric field component Ex in the x-direction by a phase angle of 90°. In the right-handed circularly polarized wave shown in (c2) in FIG. 1, E1=E2, and the electric field component Ey in the y-direction leads the electric field component Ex in the x-direction by a phase angle of 90°.

Compared with a linearly polarized wave, a circularly polarized wave or an elliptically polarized wave has advantages such as receiving incoming linearly polarized waves, reducing impact of reflected signals, and having good penetration performance. Therefore, the circularly polarized wave or the elliptically polarized wave has important applications in aspects such as communication, radar, electronic countermeasures, electronic reconnaissance, and broadcasting and television. Therefore, for an antenna mainly used in satellite communication, the antenna structure of embodiments of this application focuses on improving circular polarization performance of the antenna.

It should be noted that, in an actual application, it is difficult to implement the ideal circularly polarized wave defined above, and an elliptically polarized wave is usually implemented. Therefore, in embodiments of this application, if no special description is made, ideal circular polarization and ideal elliptical polarization of a wave are collectively referred to as circular polarization of a wave, or the ideal circularly polarized wave and the ideal elliptically polarized wave are collectively referred to as a circularly polarized wave. From another perspective, the circular polarization of the wave can be regarded as a special state of elliptical polarization.

For a circularly polarized wave in general, there is a special indicator for measuring circular polarization performance: an axial ratio (axial ratio, AR). The AR is a ratio of a major axis to a minor axis of an ellipse. Refer to FIG. 2. AR=OA/OB. For an ideal circularly polarized wave, AR=1, as shown in (c1) and (c2) in FIG. 1. For an elliptically polarized wave, AR>1, as shown in (c1) and (c2) in FIG. 1. In addition, for a linearly polarized wave, AR=∞. It can be learned that a larger axial ratio indicates poorer circular polarization performance of a wave.

### Electrical Length

The electrical length may refer to a physical length (that is, a mechanical length or a geometrical length) multiplied by a ratio of transmission time of an electric or electromagnetic signal in a medium to time required for the signal in free space passing through a distance that is the same as a physical length of the medium. The electrical length may satisfy the following formula:

$$\overline{L} = L \times \frac{a}{b}$$

where L is the physical length, a is the transmission time of the electric or electromagnetic signal in the medium, and b is the transmission time in free space.

Alternatively, the electrical length may refer to a ratio of a physical length (that is, a mechanical length or a geometrical length) to a wavelength of a transmitted electromagnetic wave. The electrical length may satisfy the following formula:

$$\overline{L} = \frac{L}{λ} ,$$

where L is the physical length, and λ is the wavelength of the electromagnetic wave.

For an antenna in a specific operating frequency band, a size of a radiator may be represented by using an electrical length of the radiator of the antenna, and a physical length of the radiator may be obtained by using the electrical length and an operating wavelength of the antenna.

### Feed Point and Feed Source

Feed point: A position (or a point) at which an antenna is connected to a feedline may be referred to as a feed point, and an electrical signal is provided to the antenna through the feed point. Selection of a position of a feed point of an antenna affects performance of the antenna. For example, radiation efficiency of the antenna is low when the feed point disposed at one position on the antenna feeds the antenna, and radiation efficiency of the antenna is high when the feed point disposed at another position on the antenna feeds the antenna.

Feed source: an excitation source configured to provide an electrical signal to a feed point. The feed source is electrically connected to a radiator of the antenna at the feed point, to feed the antenna.

### Ground Plane (Ground, GND)

A ground plane is a critically important concept and connection point in a circuit, represents a reference point or a benchmark of the circuit, and is a zero-potential position in an entire circuit system. The ground plane may be connected to other electrical components, providing a common potential reference, and implementing a potential reference and a current return path between the components. In addition, the ground plane also has shielding and protective functions, preventing electric shock to a user or damage to a device.

For devices such as a mobile phone and a tablet computer, an electronic component in an electronic device is grounded, and a structure of a metal material for implementing a grounding function in the electronic device may be used as a ground plane of the electronic device, such as a mid-frame for carrying an electronic component in the electronic device, a metal layer of a PCB, or another metal plane.

The technical solutions in embodiments of this application are applied to design of an antenna structure. An electronic device applicable to application of the antenna structure may be any device capable of communicating by using an antenna. For example, the electronic device may be a mobile phone, a tablet computer, a notebook computer, a smart band, a smart watch, a smart helmet, smart glasses, or the like. The electronic device may alternatively be a cellular phone, a cordless phone, a session initiation protocol (session initiation protocol, SIP) phone, a wireless local loop (wireless local loop, WLL) station, a personal digital assistant (personal digital assistant, PDA), a handheld device with a wireless communication function, a computing device, another processing device connected to a wireless modem, a vehicle-mounted device, a wearable device, a terminal device in a 5G network, a terminal device in a future evolved public land mobile network (public land mobile network, PLMN), or the like. This is not limited in embodiments of this application.

For ease of description, a coordinate system is defined in embodiments of this application. Every two of an x-direction, a y-direction, and a z-direction in the coordinate system are perpendicular to each other. For an electronic device described below, a z-direction may be a thickness direction of the electronic device (or a housing), a y-direction may be a length direction of the electronic device (or the housing), an x-direction may be a width direction of the electronic device (or the housing). Alternatively, the y-direction may be a width direction of the electronic device (or the housing), and the x-direction may be a length direction of the electronic device (or the housing). For example, in embodiments of this application, an example in which the y-direction is the length direction of the electronic device (or the housing), and the x-direction is the width direction of the electronic device (or the housing) is used to describe the electronic device and an antenna structure configured in the electronic device. In addition, because the x-direction, the y-direction, and the z-direction all have positive and negative directions, for ease of description, the positive direction of the x-direction is briefly referred to as a positive x-direction, and the negative direction of the x-direction is briefly referred to as a negative x-direction. Similarly, the positive and negative directions of the y-direction and the z-direction are briefly referred to as a positive y-direction, a negative y-direction, a positive z-direction, and a negative z-direction.

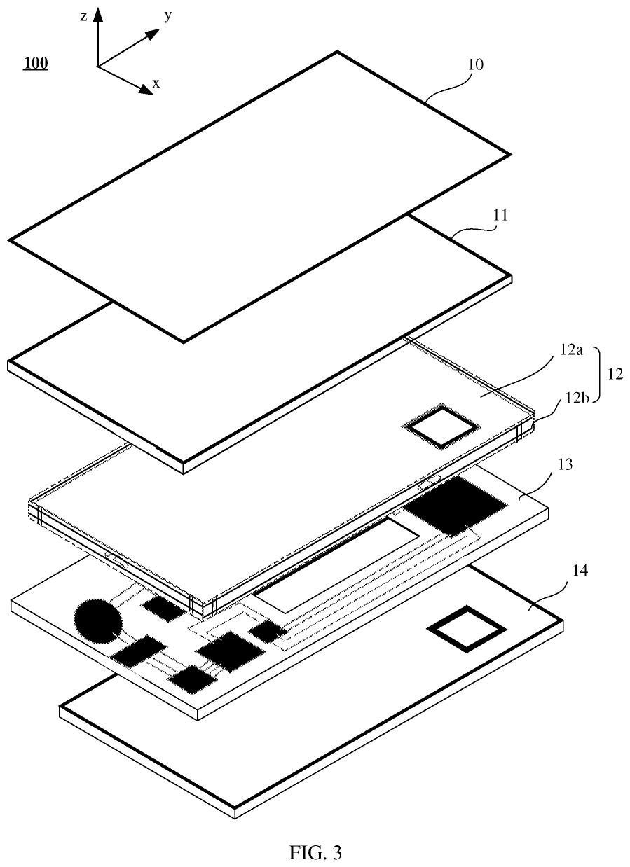

FIG. 3 is a schematic structural diagram of an electronic device according to an embodiment of this application, and primarily shows an internal environment of the electronic device. Herein, a mobile phone is used as an example of the electronic device for explanation.

Refer to FIG. 3. In a top-to-bottom sequence along a z-direction, a cover plate 10, a display screen 11, a housing 12, an internal structure 13, and a rear cover 14 may be sequentially disposed in the electronic device 100.

The cover plate 10 is a glass cover plate. The cover plate 10 is disposed closely adjacent to the display screen 11 and is mainly configured to provide protection and dust prevention for the display screen 11.

For example, the display screen 11 may be a liquid crystal display (liquid crystal display, LCD), a light emitting diode (light emitting diode, LED) display, or an organic light emitting diode (organic light emitting diode, OLED) display. This is not limited in this application.

The internal structure 13 is disposed in the housing 12, and includes a set of electronic components and mechanical components that implement various functions of the electronic device 100. For example, the internal structure 13 may include a printed circuit board (printed circuit board, PCB), a battery, a shielding can, a receiver, a front camera, a rear camera, a microphone, a speaker, a sensor, a universal serial bus (universal serial bus, USB) interface, a processor, a screw, a stiffening rib, and the like.

The rear cover 14 may be a back appearance surface of the electronic device 100. In different implementations, the rear cover 14 may use a glass material, a ceramics material, plastic, or the like.

The housing 12 may be used as a main frame of the electronic device 100 and provide rigid support for the electronic device 100. For example, the housing 12 may be made of a metal material such as aluminum alloy.

In some embodiments, the housing 12 includes a mid-frame 12a and a bezel 12b, the bezel 12b surrounds the mid-frame 12a, the mid-frame 12a is provided with the internal structure 13, to support the internal structure 13, and the bezel 12b surrounds the internal structure 13.

The bezel 12b may extend around a periphery of the electronic device 100. The bezel 12b may specifically surround four sides of the display screen 11, helping fix the display screen 11. In an example, the bezel 12b made of a metal material may be directly used as a metal bezel of the electronic device 100, to form an appearance of the metal bezel, and is applicable to a metal industrial design (industrial design, ID). In another example, an outer surface of the bezel 12b may alternatively be a non-metal material, for example, a plastic bezel, to form an appearance of a non-metal bezel, and is applicable to a non-metal ID.

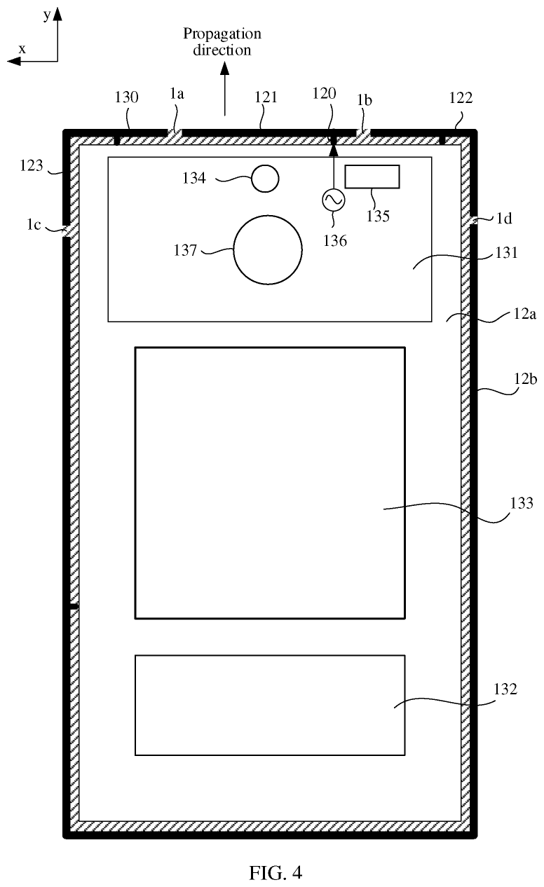

FIG. 4 is a schematic diagram of an electronic device with a rear cover removed according to an embodiment of this application. The mobile phone is still used as an example. The housing 12 and a relationship between the housing 12 and a part of the internal structure 13 are mainly described.

In some embodiments, refer to FIG. 4. The bezel 12b of the housing 12 may be a metal bezel broken by using one or more gaps, and these gaps may break the metal bezel 12b, to obtain independent metal branches. The gaps are filled with an insulating medium (for example, plastic). For example, some or all of these metal branches may be used as radiators of an antenna, thereby achieving structural reuse during an antenna arrangement process and reducing a difficulty of antenna arrangement. When a metal branch is used as a radiator of the antenna, positions of gaps correspondingly disposed at one or two ends of the metal branch may be flexibly selected based on the antenna arrangement. For example, in FIG. 4, the bezel 12b may be provided with a gap 1a, a gap 1b, a gap 1c, and a gap 1d at different positions, to form four independent metal branches. Three of the metal branches may be used as radiators of the antenna, which may be further denoted as a radiator 121, a radiator 122, and a radiator 123.

Still refer to FIG. 4. One or more metal pins 120 may be further disposed on the bezel 12b. In an example, the metal pin 120 may be provided with a screw hole, for fixing another structural member by using a screw. In another example, the metal pin 120 may further be coupled to another electronic component, to implement a corresponding electrical connection function. In another example, the metal pin 120 may be electrically connected to a feed point, so that when a metal branch connected to the metal pin 120 is used as a radiator of the antenna, the antenna is fed by using the metal pin 120. For example, the radiator 121 shown in FIG. 4 is used as an example. A feed point (not shown in the figure) is disposed on the radiator 121, a metal pin 120 connected to the radiator 121 is electrically connected to the feed point, and a feed source 136 feeds the radiator 121 at the feed point by using the metal pin 120.

The mid-frame 12a of the housing 12 is provided with a PCB. The PCB is provided with a plurality of electronic components. The plurality of electronic components include, but are not limited to, a front camera 134, a receiver 135, a rear camera (not shown in the figure), a memory (not shown in the figure), a processor (not shown in the figure), a radio frequency module (not shown in the figure), a speaker (not shown in the figure), a microphone (not shown in the figure), a USB interface (not shown in the figure), a sensor (not shown in the figure), and the like. Metals are disposed in or on surfaces of the electronic components. For example, the PCB may use a flame-retardant (FR-4) material substrate, a Rogers substrate, or a hybrid substrate combining Rogers and FR-4 materials. Herein, FR-4 is a designation of a flame-retardant material grade, and the Rogers substrate is a high-frequency laminate. A metal layer may be disposed on a side of the PCB close to the mid-frame 12a. The metal layer may be formed by etching metal on a surface of the PCB. The metal layer may be used for grounding an electronic component carried on the PCB, to prevent electric shock to a user or damage to the device. The metal layer may be referred to as a PCB ground plane. It should be understood that, the electronic device 100 is not limited to having the PCB ground plane, and may further have another ground plane for grounding, for example, the mid-frame 12a or another metal plane in the electronic device.

Still refer to FIG. 4. The electronic device 100 further includes a battery 133, and the battery 133 may partition a PCB into a main board and a sub-board. For example, a PCB 131 may be used as a main board of the electronic device 100, and is located, for example, between an upper side (that is, a part in the positive direction of the y-direction) of the bezel 12b and an upper side of the battery 133. A PCB 132 may be used as a sub-board of the electronic device 100, and is located, for example, between a lower side (that is, a part in the negative direction of the y-direction) of the bezel 12b and a lower side of the battery 133. In an example, the PCB 131 and the PCB 132 may be completely separated by the battery 133 shown in FIG. 4. In another example, the PCB 131 and the PCB 132 may further be connected, for example, in an L-type PCB design (not shown in the figure). It should be understood that an “upper side” and a “lower side” of a component herein indicate a part of the component in a positive aspect of the y-direction and a part of the component in a negative aspect of the y-direction in the orientation shown in FIG. 4, and should not be construed as a limitation to this application.

For example, components such as the front camera 134, the receiver 135, the rear camera 137, the memory (not shown in the figure), the processor (not shown in the figure), and the radio frequency module may be disposed on the PCB 131 serving as the main board. The radio frequency module mainly includes: a power amplifier, an antenna switch module, a front-end module, a duplexer, a filter, a synthesizer, and the like. For example, components such as the speaker, the microphone, the USB interface, and a related circuit may be disposed on the PCB 132 serving as a sub-board. In addition, a radio frequency module corresponding to an antenna and located at a bottom (that is, a part in the negative direction of the y-direction of the electronic device) of the electronic device, and the like may further be disposed on the PCB 132.

In the foregoing example, the PCB 131, the PCB 132, the battery 133, and the components disposed on the PCB 131 and the PCB 132 may be some or all components of the internal structure 13 shown in FIG. 3.

In the electronic device, the mid-frame 12a, the PCBs, or any metal layer or metal plane that can be electrically connected to the mid-frame 12a may be used as a ground plane for grounding an electronic component, to prevent electric shock to a user or damage to the device. It should be understood that the mid-frame 12a is used as the ground plane. Because the PCBs are disposed on the mid-frame 12a and can be electrically connected to the mid-frame 12a, the PCBs may also be used as the ground planes, or an entirety of the mid-frame 12a and the PCBs may be used as the ground plane.

Still refer to FIG. 4. When some or all of the metal branches of the bezel 12b are used as radiators of the antenna, a medium layer 130 is further formed in the electronic device 100, to isolate different radiators and isolate the radiators from the ground plane. Gaps between the radiators and the mid-frame 12a serving as the ground plane form a clearance region. The clearance region is filled with an insulating medium (for example, plastic). In addition, gaps between the radiators are also filled with insulating media, and these filled media form the medium layer 130. For example, the medium layer 130 may be formed by using a nano molding technology (nano molding technology, NMT), and plastic particles belong to a medium material.

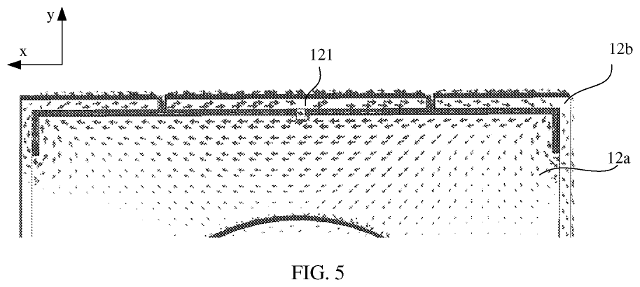

In the related technology, a mobile phone and satellite communication are used as an example. Still refer to FIG. 4. A radiator of an antenna structure used for satellite communication may be a part of a metal branch of the bezel 12b of the mobile phone, and the radiator may be the radiator 121 located at a top end (that is, a part in the positive y-direction shown in FIG. 5) of the mobile phone. In this way, when a user holds the mobile phone in a normal manner, the antenna structure located at the top end of the mobile phone is less likely to be covered by the hand, and performance of the antenna structure is not additionally affected. In this structure, a propagation direction of a wave radiated by the antenna is near the positive y-direction. That the propagation direction is the positive y-direction is used as an example herein for description. The propagation direction is perpendicular to a plane (that is, an xz plane) in which the radiator 121 is located. A feed point (not shown in the figure) is disposed on the radiator 121, and the feed source 136 feeds the radiator 121 at the feed point. However, such an antenna structure has poor circular polarization performance and poor user experience.

The following explains and describes, with reference to simulation effect drawings corresponding to the antenna structures shown in FIG. 5 to FIG. 8, the antenna structure shown in FIG. 4 by using an example in which operating frequencies of the antenna structure are 2.2 Ghz and 2.0 Ghz and the antenna structure is configured to receive and send a left-handed circularly polarized wave. Certainly, the antenna structure may alternatively be configured to receive and send a right-handed circularly polarized wave. This is not limited in embodiments of this application.

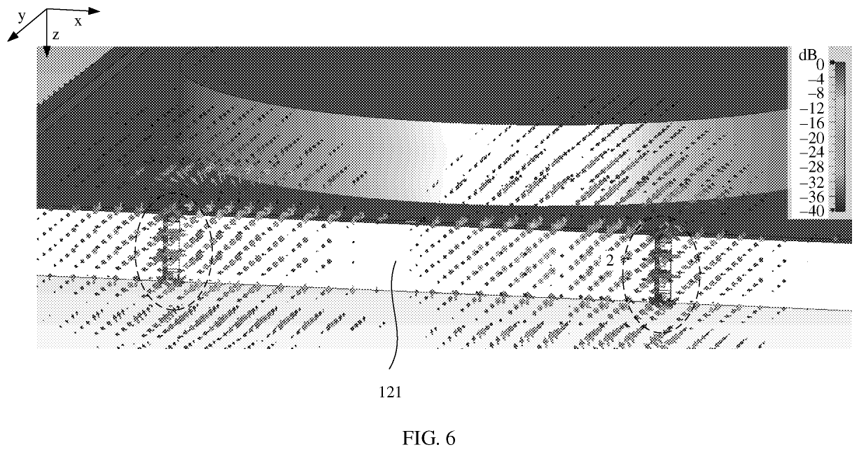

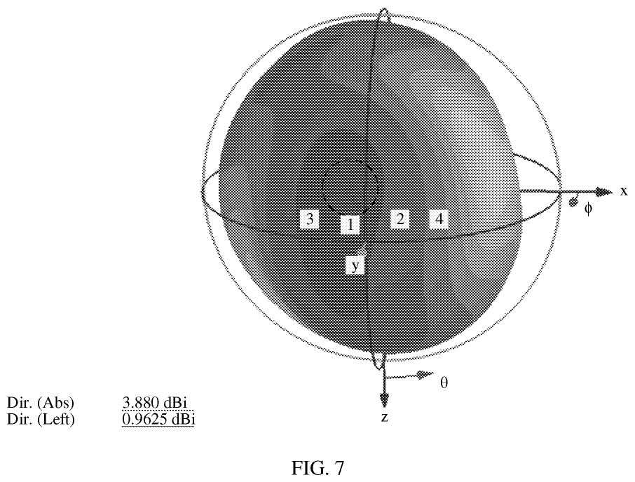

FIG. 5 is a current distribution diagram of a local region near an antenna structure in the electronic device shown in FIG. 4, when an operating frequency of a prior-art antenna structure is 2.2 Ghz. FIG. 6 is a distribution diagram of an electric field in a local region near an antenna structure in the electronic device shown in FIG. 4, when an operating frequency of a prior-art antenna structure is 2.2 Ghz. FIG. 7 is a diagram of left-handed circular polarization directivity of the electronic device shown in FIG. 4, when an operating frequency of a prior-art antenna structure is 2.2 Ghz. FIG. 8 is a diagram of left-handed circular polarization directivity of the electronic device shown in FIG. 4, when an operating frequency of a prior-art antenna structure is 2.0 Ghz.

In FIG. 5, the radiator 121 generates radiation in a region in the positive y-direction of the bezel 12b. In FIG. 6, for a wave whose propagation direction is the positive y-direction, an electric field component distributed along the x-direction (shown in a dashed region in the figure) and an electric field component distributed along the z-direction (which is barely visible) are generated, but there are few electric field components in the z-direction. It can be known based on a formation mechanism of a circularly polarized wave that, two perpendicular and orthogonal electric field components need to exist in a perpendicular plane (for example, an xz plane) of a wave propagation direction (for example, the positive y-direction). Although the foregoing antenna structure generates the electric field component distributed along the x-direction and the electric field component distributed along the z-direction, the weak z-direction electric field component is unfavorable for the formation of the circularly polarized wave, resulting in poor circular polarization performance of the antenna structure.

When the antenna structure is configured to receive and send a left-handed circularly polarized wave, attention is paid to a left-handed circular polarization directivity of the antenna structure. When the antenna structure is configured in the electronic device for data simulation, simulation is performed on the electronic device as a whole, and obtained left-handed circular polarization directivity is a left-handed circular polarization directivity of the entire electronic device. For the left-handed circular polarization directivity of interest within a directional range (for example, a direction near the positive y-direction) that is for receiving and sending the left-handed circularly polarized wave, there is a left-handed circular polarization directivity in each direction within the directional range. A maximum left-handed circular polarization directivity within the directional range is used as a left-handed circular polarization directivity of the directional range, and a direction in which the maximum left-handed circular polarization directivity is located is within the directional range. In FIG. 7, a region marked by a dashed circle is the directional range of interest that is for receiving and sending the left-handed circularly polarized wave. A lower left corner of FIG. 7 showing the left-handed circular polarization directivity displays the left-handed circular polarization directivity of the electronic device. The left-handed circular polarization directivity represents a maximum left-handed circular polarization directivity of the electronic device, and the maximum left-handed circular polarization directivity is a left-handed circular polarization directivity of the electronic device in a specific direction. Because a direction in which the maximum left-handed circular polarization directivity of the electronic device is located lies in the region marked by the dashed circle, the left-handed circular polarization directivity of the electronic device shown in FIG. 7 may be considered as the left-handed circular polarization directivity within the directional range of interest that is marked by the dashed circle and that is for receiving and sending the left-handed circularly polarized wave. Based on this, a left-handed circular polarization directivity of the antenna structure obtained in a simulation result in FIG. 7 is 0.9625 dBi.

FIG. 8 is a diagram of left-handed circular polarization directivity of the electronic device shown in FIG. 4, when an operating frequency of a prior-art antenna structure is 2.0 Ghz. (a) in FIG. 8 is a diagram of a left-handed circular polarization direction in a spherical coordinate system. (b) in FIG. 8 is a diagram of a left-handed circular polarization direction in a two-dimensional coordinate system, where a horizontal coordinate is an azimuth angle (azimuth angle) φ with a value range of [0, 360], and a perpendicular coordinate is a polar angle (polar angle) θ with a value range of [0, 180]. The azimuth angle φ is an angle measured along a clockwise direction starting from the y-direction on an equatorial plane (a plane determined by the y-direction and the x-direction), and the polar angle θ is an angle between a z-direction and a radial distance r, where r is a distance between a spherical coordinate point and a spherical center.

For the left-handed circular polarization directivity within the directional range of interest that is for receiving and sending the left-handed circularly polarized wave and that is marked by the dashed circle, a direction in which the left-handed circular polarization directivity of the electronic device shown at the lower left corner of the left-handed circular polarization directivity diagram in (a) in FIG. 8 is located is not within the directional range of interest that is marked by the dashed circle. Therefore, the directional range of interest that is marked by the dashed circle is found in (b) in FIG. 8, and a maximum left-handed circular polarization directivity within the directional range is used as a left-handed circular polarization directivity of the directional range. The maximum left-handed circular polarization directivity is −0.6411 dBi, and coordinates of the maximum left-handed circular polarization direction are (φ=95°, θ=95°). In other words, the left-handed circular polarization directivity of the antenna structure obtained in the simulation result in FIG. 8 is −0.6411 dBi.

In conclusion, it can be learned that, regardless of an operating frequency, circular quantization performance of the antenna structure in the existing technology is poor.

Based on the foregoing problem of poor circular quantization performance of the antenna structure, embodiments of this application provide a new antenna structure and an electronic device provided with the antenna structure. The antenna structure includes two radiators that are mutually non-contacting. A first radiator is disposed on one side of a ground plane (for example, a part of a bezel may be formed as the first radiator). A second radiator is disposed above and parallel to the ground plane. The antenna structure is fed by using a feed point disposed on at least one radiator, so that the two radiators perform energy coupling to radiate an electromagnetic wave. In addition, the antenna structure can generate electric field components in two directions (for example, an x-direction and a z-direction) that are perpendicular to each other. In the foregoing structure, based on the second radiator disposed above and parallel to the ground plane, additional electric field components can be provided in a direction (for example, the z-direction) perpendicular to a plane in which the ground plane is located, thereby improving circular polarization performance of the antenna structure.

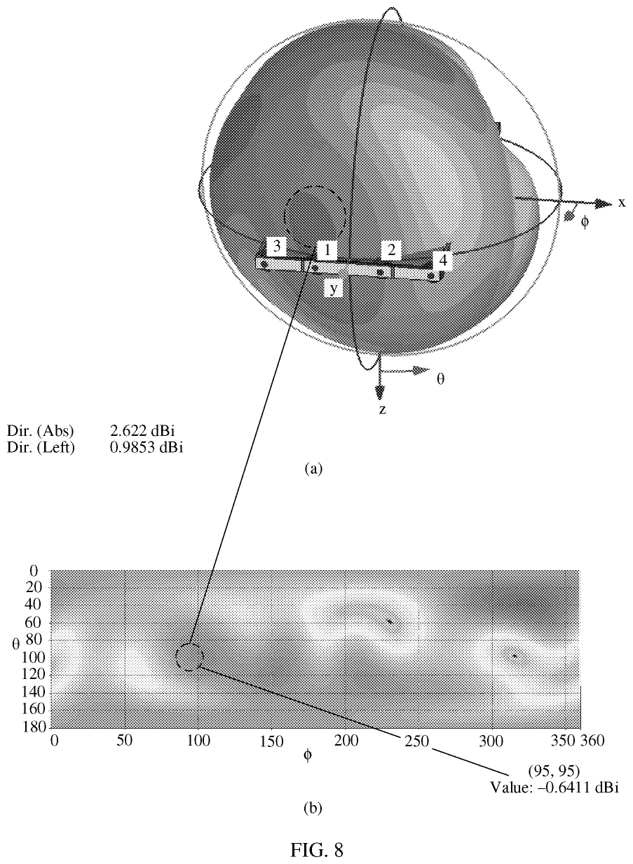

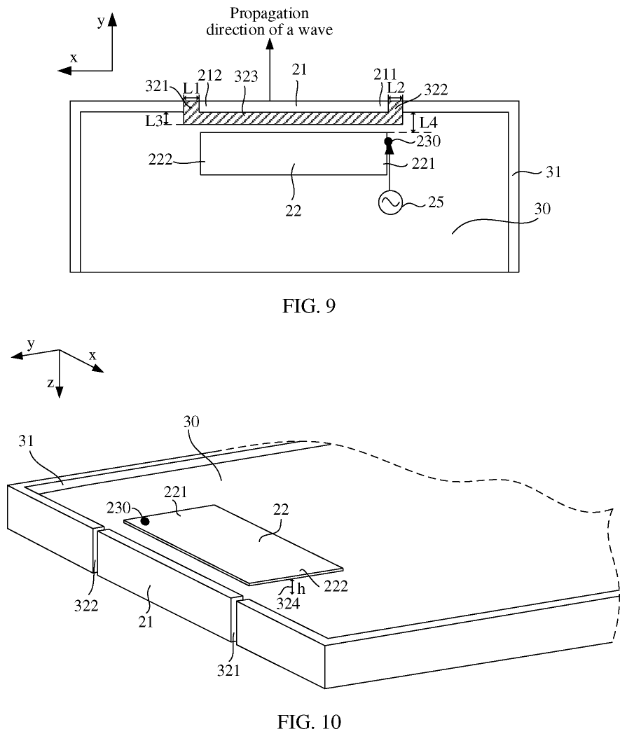

FIG. 9 is a schematic diagram of a local region near a first antenna structure in an electronic device according to an embodiment of this application. FIG. 10 is a three-dimensional schematic diagram of a local region near a first antenna structure in an electronic device according to an embodiment of this application.

Refer to FIG. 9 and FIG. 10. The electronic device includes a first antenna structure and a ground plane 30. The first antenna structure includes a first radiator 21 and a second radiator 22. The first radiator 21 is disposed on a side of the ground plane 30, and a first gap 323 is spaced between the first radiator 21 and the ground plane 30. The second radiator 22 is disposed above and parallel to the ground plane 30, and a second gap 324 is spaced between the second radiator 22 and the ground plane 30 (shown in FIG. 10). The first radiator 21 and the second radiator 22 are mutually non-contacting. At least one of the first radiator 21 and the second radiator 22 is provided with a feed point 230. FIG. 9 and FIG. 10 merely show a structure in which one feed point 230 is disposed on the second radiator 22. For other examples, refer to the following descriptions. When being fed at the feed point 230, the first radiator 21 and the second radiator 22 operate at a same operating frequency. In this way, energy coupling can be performed between the first radiator 21 and the second radiator 22 to radiate an electromagnetic wave. In addition, the first antenna structure can generate an electric field component distributed along a first direction (for example, an x-direction) and an electric field component distributed along a second direction (for example, a z-direction). The first direction (for example, the x-direction) is perpendicular to the second direction (for example, the z-direction). The first direction (for example, the x-direction) is parallel to a length direction of the first radiator 21. The second direction (for example, the z-direction) is perpendicular to a plane in which the ground plane 30 is located.

The ground plane 30 may be any metal layer or metal plane of the electronic device. For example, the ground plane 30 may be a mid-frame, a PCB, or the like of the electronic device, and is used for grounding an electronic component, to prevent electric shock to a user or damage to the device.

Still refer to FIG. 9 and FIG. 10. The first radiator 21 is disposed on a side of the ground plane 30. For example, the first radiator 21 is perpendicular to the ground plane 30. To be specific, a plane (for example, an xz plane) in which the first radiator 21 is located is perpendicular to a plane (for example, an xy plane) in which the ground plane 30 is located. It should be understood that “perpendicular” herein means substantial perpendicularity, where an angle between the two elements may be within a specific error range. For example, the error range may be greater than or equal to 0° and less than or equal to 15°. For example, an angle between the first radiator 21 and the ground plane 30 may be between 75° and 105°. Herein, the range of the angle between 75° and 105° includes boundary values 75° and 105°. Descriptions about “perpendicular” provided below are the same as the descriptions herein. Details are not described again.

It should be further understood that the plane in which the first radiator 21 is located represents a plane having a largest projection area of the first radiator 21.

For example, the plane having the largest projection area of the first radiator 21 is the xz plane, and therefore, the plane in which the first radiator 21 is located is the xz plane. Descriptions about the plane in which the ground plane 30 is located and a plane in which another component such as the second radiator 22 is located that are provided below are the same as the descriptions herein. Details are not described again.

Still refer to FIG. 9. The first gap 323 between the first radiator 21 and the ground plane 30 may be referred to as a clearance of the first radiator 21 relative to the ground plane 30. That is, a distance between a projection of the first radiator 21 in the plane (for example, the xy plane) in which the ground plane 30 is located and the ground plane 30 is the clearance. It may be understood that, within a specific range, a large-sized clearance helps improve performance of the antenna structure, for example, can effectively improve bandwidth of the antenna structure.

A size of the first gap 323 is denoted as L3. For example, the size L3 of the first gap 323 may be less than or equal to 2 mm. This size range is very applicable to, for example, a lightweight handheld device such as a mobile phone, a tablet computer, or a notebook computer. For example, the size L3 of the first gap 323 may be 2 mm, 1.5 mm, 1 mm, 0.8 mm, 0.6 mm, or 0.5 mm.

In some embodiments, an electrical length of the first radiator 21 in the first direction (for example, the x-direction) is between a one-quarter wavelength and a one-half wavelength, where the wavelength is an operating wavelength of the first antenna structure. Herein, a range of the electrical length between the one-quarter wavelength and the one-half wavelength includes boundary values of the one-half wavelength and the one-quarter wavelength. It may be understood that an electrical length or a physical length of a radiator described in this application represents a size of the radiator in a length direction (for example, the x-direction) of the radiator. For detailed descriptions of the electrical length, refer to related descriptions above. Details are not described again.

Certainly, in other embodiments, the electrical length of the first radiator 21 in the first direction (for example, the x-direction) may alternatively be a wavelength (for example, a one-eighth wavelength) in another range. This is not limited herein.

In some embodiments, the first radiator 21 may be a part of a metal bezel of the electronic device. Still refer to FIG. 9 and FIG. 10, a bezel 31 of the electronic device is interrupted by a gap 321 and a gap 322, and an obtained independent metal branch is used as the first radiator 21 of the first antenna structure. In other words, the first radiator 21 is a part of the bezel 21.

Still refer to FIG. 9 and FIG. 10. The second radiator 22 is disposed in parallel to the ground plane 30. That is, the second radiator 22 is disposed on the ground plane 30, and the second radiator 22 is parallel to the ground plane 30. In other words, a plane (for example, an xy plane) in which the second radiator 22 is located is parallel to a plane (for example, an xy plane) in which the ground plane 30 is located. It should be understood that “parallel” herein means substantial parallelization, where an angle between the two elements may be within a specific error range. For example, the error range may be greater than or equal to 0° and less than or equal to 15°. For example, an angle between the second radiator 22 and the ground plane 30 may be between 0° and 15°. Herein, the range of the angle between 0° and 15° includes boundary values 0° and 15°. Descriptions about “parallel” provided below are the same as the descriptions herein. Details are not described again.

For example, a length direction of the first radiator 21 is parallel to a length direction of the second radiator 22.

Still refer to FIG. 10. When the second radiator 22 is disposed on the ground plane 30, the second gap 324 between the second radiator 22 and the ground plane 30 is a height difference of the second radiator 22 relative to the ground plane 30 in a second direction (for example, a z-direction) perpendicular to a plane (for example, an xy plane) in which the ground plane 30 is located, and the height difference may be referred to as an operating height.

A size of the second gap 324 is denoted as h. For example, the size h of the second gap 324 is less than or equal to 3 mm. For example, the size h of the second gap 324 may be 3 mm, 2.5 mm, 2 mm, 1.8 mm, 1.5 mm, 1 mm, or the like. This size range is very applicable to, for example, a lightweight handheld device such as a mobile phone, a tablet computer, or a notebook computer. A mobile phone or a tablet computer is used as an example. A common thickness is 7 mm to 10 mm. In the range of 7 mm to 10 mm, theoretically, a larger value of h is more conducive to performance enhancement of the antenna structure. Because components disposed along a thickness direction such as a display screen, a rear cover, and a PCB occupy a part of size, a value of h less than or equal to 3 mm is therefore appropriate.

In some embodiments, the second radiator 22 may be formed on a support member such as an antenna holder by using a laser direct structuring (laser direct structuring, LDS) technology, a flexible printed circuit (flexible printed circuit, FPC) technology, a floating metal (FLM) technology, or a PCB technology. This is not limited in this application.

In some embodiments, an electrical length of the second radiator 22 in the first direction (for example, the x-direction) is between a one-quarter wavelength and a one-half wavelength. Certainly, in other embodiments, the electrical length of the second radiator 22 in the first direction (for example, the x-direction) may alternatively be a wavelength (for example, a one-eighth wavelength) in another range. This is not limited herein.

In embodiments of this application, the second radiator 22 is disposed on the ground plane 30, the second gap 324 is spaced between the second radiator 22 and the ground plane 30, and the antenna holder disposed on the ground plane 30 may support the second radiator 22, or another component may support the second radiator 22.

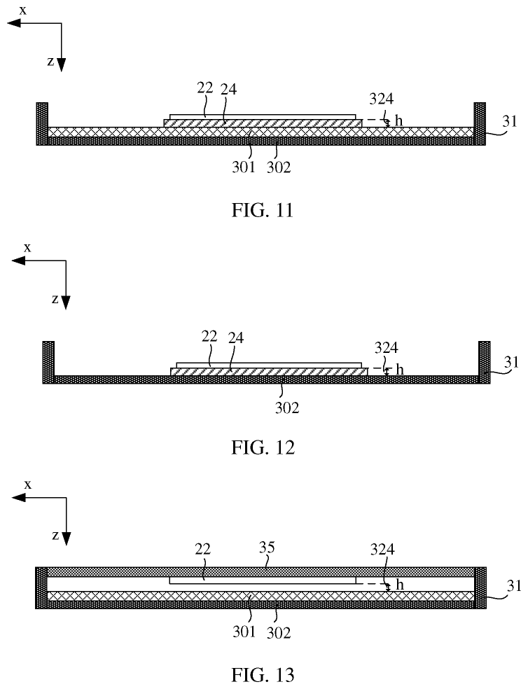

FIG. 11 is a cross-sectional view of an electronic device configured with a first antenna structure according to an embodiment of this application. FIG. 12 is another cross-sectional view of an electronic device configured with a first antenna structure according to an embodiment of this application. FIG. 13 is another cross-sectional view of an electronic device configured with a first antenna structure according to an embodiment of this application.

In some embodiments, refer to FIG. 11. In a sequence from bottom to top along a z-direction, a mid-frame 302 is provided with a PCB 301, the PCB 301 is electrically connected to the mid-frame 302, the PCB 301 is provided with an antenna holder 24, and the second radiator 22 is disposed on the antenna holder 24. Herein, the ground plane 30 is the PCB 301, the antenna holder 24 is formed by using an insulating medium (for example, plastic), the antenna holder 24 is used as a support member of the second radiator 22, and the second radiator 22 is disposed, by using the antenna holder 24, on the PCB 301 serving as the ground plane 30.

In some other embodiments, refer to FIG. 12. In a sequence from bottom to top along the z-direction, a mid-frame 302 is provided with an antenna holder 24, and the second radiator 22 is disposed on the antenna holder 24. Herein, the ground plane 30 is the mid-frame 302, and the second radiator 22 is disposed, by using the antenna holder 24, on the mid-frame 302 serving as the ground plane 30. It may be understood that, in the embodiments, a PCB is located in another region of the electronic device, and the PCB and the second radiator 22 do not overlap with each other in the z-direction.

In the foregoing example, the second radiator 22 is disposed on the ground plane 30 by using the antenna holder 24. In another example, no antenna holder may not be required for the second gap 324 between the second radiator 22 and the ground plane 30.

In some other embodiments, refer to FIG. 13. The PCB 301 is used as an example of the ground plane 30, there is no antenna holder in the second gap 324 between the second radiator 22 and the PCB 301, the second radiator 22 is fixedly disposed on a rear cover 35 of the electronic device, and the rear cover 35 is used as a support member of the second radiator 22.

In embodiments of this application, the first radiator 21 and the second radiator 22 are mutually non-contacting, indicating that the two radiators are physically absolutely isolated. Still refer to FIG. 9. The ground plane 30 is used as a reference object, two projections of the first radiator 21 and the second radiator 22 in a plane (for example, an xy plane) in which the ground plane 30 is located do not overlap with each other, the two projections have a gap, and a size of the gap is L4.

Regarding the feed point 230, at least one of the first radiator 21 and the second radiator 22 is provided with the feed point 230.

In some embodiments, at least one of the first radiator 21 and the second radiator 22 is provided with a plurality of feed points 230, that is, a plurality of feed points may be disposed in the first antenna structure 230. Such a manner of disposing a plurality of feed points in the antenna structure is referred to as distributed feeding. The plurality of feed points 230 may be distributed on the first radiator 21, or distributed on the second radiator 22, or distributed on the first radiator 21 and the second radiator 22. This is not limited herein. When the plurality of feed points 230 are distributed on the first radiator 21 and the second radiator 22, a quantity of the feed points 230 on the first radiator 21 and the second radiator 22 may be random, and is specifically designed based on an actual situation. For example, the first radiator 21 is provided with one feed point 230, and the second radiator 22 is provided with two feed points 230.

In some other embodiments, the first antenna structure is provided with one feed point 230, and the feed point 230 is disposed on one of the first radiator 21 and the second radiator 22. It may be understood that, the design of disposing one feed point 230 in the first antenna structure is simple and convenient to implement.

In an example, refer to FIG. 9 and FIG. 10. The second radiator 22 is provided with the feed point 230.

Compared with the existing technology, the second radiator 22 is a newly added radiator, for a purpose of providing additional electric field components in the second direction (for example, the z-direction) perpendicular to the plane (for example, the xy plane) in which the ground plane 30 is located, the feed point 230 is disposed on the second radiator 22, so that the second radiator 22 is more fully excited, and more electric field components can be provided in the second direction (for example, the z-direction) perpendicular to the plane in which the ground plane 30 is located. In addition, in an embodiment in which the first radiator 21 is a part of the metal bezel of the electronic device, because parts such as a display screen and a receiver around the bezel 31 affect performance of the first radiator 21, disposing the feed point 230 on the second radiator 22 can reduce impact of these components on the first antenna structure to some extent.

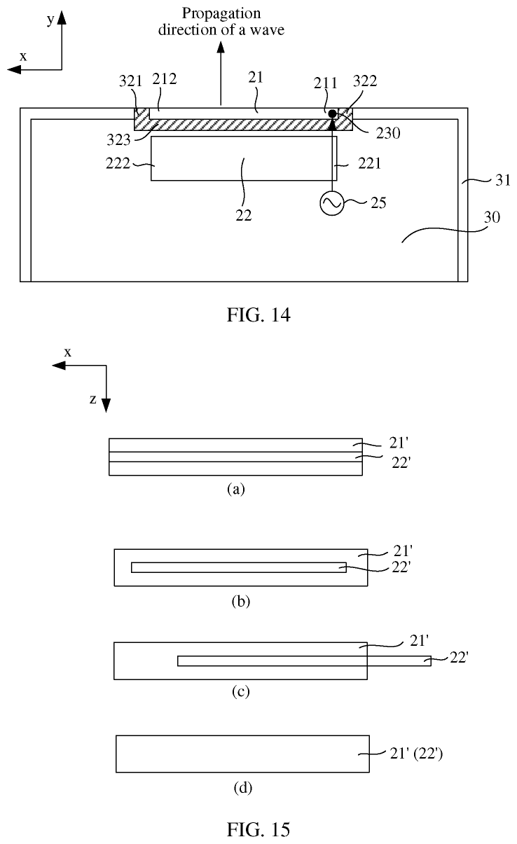

In another example, FIG. 14 is another schematic diagram of a local region near a first antenna structure in an electronic device according to an embodiment of this application. Refer to FIG. 14. The first radiator 21 is provided with the feed point 230.

In the foregoing embodiment in which the first antenna structure is provided with one feed point 230, in some embodiments, the feed point 230 is disposed in proximity to the other radiator that is not provided with a feed point 230. For example, in FIG. 9 and FIG. 10, the feed point 230 is disposed on the second radiator 22, and the feed point 230 is disposed in proximity to the first radiator 21. For another example, in FIG. 14, the feed point 230 is disposed on the first radiator 21, and the feed point 230 is disposed in proximity to the second radiator 22.

In the foregoing embodiment, the two radiators are mutually non-contacting. An electromagnetic wave is radiated through energy coupling, and the feed point 230 is disposed in proximity to the other radiator that is not provided with a feed point 230, so that an energy loss can be reduced, and coupling performance of the first antenna structure can be improved.

In the foregoing embodiment in which the first antenna structure is provided with one feed point 230, in some embodiments, one end, distributed along the first direction (for example, the x-direction), of one of the first radiator 21 and the second radiator 22 is provided with the feed point 230).

That is, the radiator provided with the feed point 230 has two end portions distributed along the first direction (for example, the x-direction), and the feed point 230 may be disposed at either of the two end portions. Such a structure in which the feed point 230 is disposed at an end portion of the radiator 21 helps form a left-handed circularly polarized wave or a right-handed circularly polarized wave.

An example in which the feed point 230 is disposed on the second radiator 22 is used. Refer to FIG. 9 and FIG. 10. A coordinate system shown in the figure is used as a reference. The second radiator 22 has two end portions distributed along the first direction (for example, the x-direction), which are denoted as a first end 221 and a second end 222. In an example, the feed point 230 is disposed at the first end 221 of the second radiator 22. In other words, the feed point 230 is disposed at an end portion, located in a negative x-direction, of the second radiator 22. It may be understood that such a disposing manner is beneficial to adjusting a phase difference between two perpendicular and orthogonal electric field components (for example, electric field components in the x-direction and the z-direction) generated by the first antenna structure, so that the phase difference satisfies a phase requirement of left-handed circular polarization, and is beneficial to forming a left-handed circularly polarized wave.

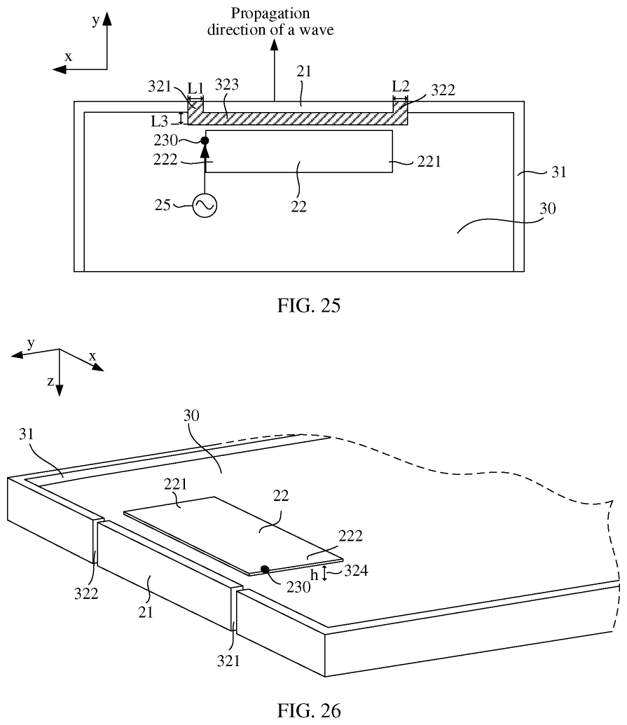

An example in which the feed point 230 is disposed on the second radiator 22 is used. In another example, the feed point 230 is disposed at the second end 222 of the second radiator 22. In other words, the feed point 230 is disposed at an end portion, located in a positive x-direction, of the second radiator 22. Such a disposing manner is beneficial to forming a right-handed circularly polarized wave. For specific descriptions, refer to the following specific descriptions about FIG. 25 and FIG. 26.

It should be understood that, the first end 221 of the second radiator 22 may be a section, a face, or a part of the second radiator 22 away from an endpoint. In other words, distances between all points on the first end 221 of the second radiator 22 and the endpoint are less than a threshold, and cannot be understood as that the first end is definitely one point in a narrow sense. Descriptions about the second end 222 of the second radiator 22 are the same as those herein. Descriptions about an end portion or an end of a part or a structure below are also the same as those herein. Details are not described below again.

It should be further understood that, in the foregoing descriptions, one end (the first end 221 or the second end 22), distributed along the first direction (for example, the x-direction), of the second radiator 22 may also be described as “one end, extending along a third direction (for example, the y-direction), of the second radiator 22”. The two terms may be alternately used for descriptions. One end (a first end 211 or a second end 212), distributed along the first direction (for example, the x-direction), of the first radiator 21 may alternately be described as “one end, extending along a third direction (for example, the y-direction), of the first radiator 21”.

An example in which the feed point 230 is disposed on the first radiator 21 is used. Refer to FIG. 14. The first radiator 21 has two end portions distributed along the first direction (for example, the x-direction), which are denoted as the first end 211 and the second end 212. In an example, the feed point 230 is disposed at the first end 211 of the first radiator 21. In other words, the feed point 230 is disposed at an end portion, located in a negative x-direction, of the first radiator 21. Such a disposing manner is beneficial to forming a left-handed circularly polarized wave.

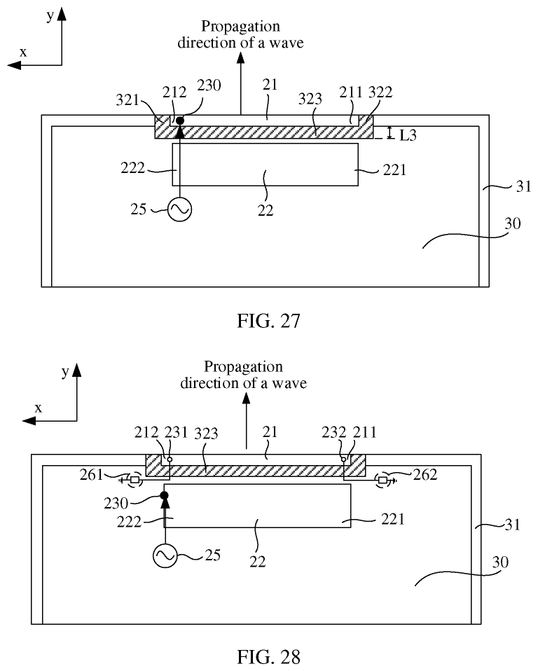

An example in which the feed point 230 is disposed on the first radiator 21 is used. In another example, the feed point 230 is disposed at the second end 212 of the first radiator 21. In other words, the feed point 230 is disposed at an end portion, located in a positive x-direction, of the first radiator 21. Such a disposing manner is beneficial to forming a right-handed circularly polarized electromagnetic wave. For specific descriptions, refer to the following specific descriptions about FIG. 27.

In the foregoing embodiments, three directions are defined: the first direction, the second direction, and the third direction, and the three directions are perpendicular to each other.

The first direction (for example, the x-direction) is a direction parallel to the length direction of the first radiator 21 or the length direction of the second radiator 22. The second direction (for example, the z-direction) is a direction perpendicular to the plane in which the ground plane 30 or the second radiator 22 is located. Because the radiator is a metal layer or a metal sheet having a small thickness, the second direction may also be represented as a direction parallel to a thickness direction of the second radiator 22. The third direction (for example, the y-direction) is perpendicular to both the first direction and the second direction. At another angle, the third direction may be represented as a direction parallel to the plane (for example, the xy plane) in which the ground plane 30 is located and perpendicular to the first direction (for example, the x-direction).

In the foregoing embodiments, the first radiator 21 is disposed on a side of the ground plane 30, and the second radiator 22 is disposed above and parallel to the ground plane 30. The first antenna structure is fed by using the feed point 230 disposed on at least one radiator, so that the first radiator 21 and the second radiator 22 can perform energy coupling to radiate an electromagnetic wave, and an electric field component distributed along the first direction (for example, the x-direction) and an electric field component distributed along the second direction (for example, the z-direction) can be generated. A propagation direction of the first antenna structure is approximately parallel to a third direction (for example, a y-direction). For example, the propagation direction is a positive y-direction. Because the second radiator 22 disposed above the ground plane 30 is added, the second radiator 22 can provide additional electric field components in the second direction (for example, the z-direction) perpendicular to the plane in which the ground plane 30 is located, so that electric field components of the second radiator 22 in the second direction (for example, the z-direction) are increased. In addition, the first radiator 21 itself can provide sufficient electric field components in the first direction (for example, the x-direction). In this way, on a plane (for example, an xz plane) perpendicular to a propagation direction of the electromagnetic waves, two perpendicular and orthogonal electric field components (for example, an electric field component in the x-direction and an electric field component in the y-direction) can be desirably formed. This facilitates formation of a circularly polarized wave, thereby improving circular polarization performance of the first antenna structure.

It should be noted that, the first radiator 21 and the second radiator 22 of the first antenna structure in embodiments of this application do not need to be provided with a grounding point. This avoids reduction of electric field components, thereby preventing degradation of circular polarization performance of the first antenna structure to some extent. It may be understood that if a grounding point is disposed on the second radiator 22, a part of current flows to the ground plane 30. Consequently, a decrease in current in the second radiator 22 causes a decrease in electric field components in the second direction (for example, the z-direction), which is not beneficial to formation of a circularly polarized wave. Similarly, if a grounding point is disposed on the first radiator 21, a part of current flows to the ground plane 30. Consequently, a decrease in current in the first radiator 21 causes a decrease in electric field components in the first direction (for example, the x-direction), which is not beneficial to formation of a circularly polarized wave.

In embodiments of this application, in some embodiments, refer to FIG. 9. Two ends of the second radiators 22 that are distributed along the first direction (for example, the x-direction) are respectively flush with two ends of the first radiator 21 that are distributed along the first direction (for example, the x-direction). It should be understood that the statement “the respective ends of the two radiators are flush” indicates that end portions of the two radiators located on a same side are flush with each other. Specifically, the second radiator 22 has two end portions: the first end 221 and the second end 222 that are distributed along the first direction (for example, the x-direction). The first radiator 21 has two end portions: the first end 211 and the second end 212 that are distributed along the first direction (for example, the x-direction). The first end 221 of the second radiator 22 is flush with the first end 211 of the first radiator 21, and the second end 222 of the second radiator 22 is flush with the second end 212 of the first radiator 21.

It should be understood that the term “same” herein indicates substantially same, not necessarily exactly the same. Both elements may vary within a specific error tolerance. For example, in terms of a physical length, an error range between two physical lengths may be greater than or equal to 0 mm and less than or equal to 5 mm.

It should be further understood that end portions of the two radiators described herein are flush, and do not need to be completely flush, provided that the two radiators are within a specific error range.

In the foregoing embodiments, the two ends of the first radiator 21 that are distributed along the first direction (for example, the x-direction) are respectively flush with the two ends of the second radiator 22 that are distributed along the first direction (for example, the x-direction), which means that electrical lengths (or physical lengths) of the two radiators along the first direction (for example, the x-direction) are basically the same. This disposing manner increases an area for energy coupling between the two radiators, so that energy coupling between the two radiators is better.

In some other embodiments, one end, distributed along the first direction (for example, the x-direction), of the second radiator 22 is not flush with respect to one end of the first radiator 21 on a same side, and the other end, distributed along the first direction (for example, the x-direction), of the second radiator 22 is flush or not flush with the other end of the first radiator 21 on a same side.

Herein, that the end portions of the two radiators are “not flush” means that one end of one radiator extends outward or retracts relative to one end of the other radiator on a same side.

It should be understood that the “one end of the first radiator 21 on a same side” described above refers to one end, distributed along the first direction (for example, the x-direction), of the first radiator 21. Furthermore, the end, distributed along the first direction (for example, the x-direction), of the first radiator 21 and the end, distributed along the first direction (for example, the x-direction), of the second radiator 22 are located on a same side of the first antenna structure. Explanations about “the other end of the first radiator 21 on a same side” are the same as those herein.

It should be further understood that, one end, distributed along the first direction (for example, the x-direction), of the second radiator 22 indicates either of two ends, distributed along the first direction (for example, the x-direction), of the second radiator 22, and the other end, distributed along the first direction (for example, the x-direction), of the second radiator 22 indicates the other one of the two ends, distributed along the first direction (for example, the x-direction), of the second radiator 22.

For example, the first end 221, distributed along the first direction (for example, the x-direction), of the second radiator 22 retracts relative to the first end 211 of the first radiator 21 on the same side, and the second end 222, distributed along the first direction (for example, the x-direction), of the second radiator 22 is flush relative to the second end 212 of the first radiator 21 on the same side (shown in FIG. 34). For another example, the first end 221, distributed along the first direction (for example, the x-direction), of the second radiator 22 extends outward relative to the first end 211 of the first radiator 21 on the same side, and the second end 222, distributed along the first direction (for example, the x-direction), of the second radiator 22 is flush with the second end 212 of the first radiator 21 on the same side. For another example, the first end 221, distributed along the first direction (for example, the x-direction), of the second radiator 22 retracts relative to the first end 211 of the first radiator 21 on the same side, and the second end 222, distributed along the first direction (for example, the x-direction), of the second radiator 22 retracts relative to the second end 212 of the first radiator 21 on the same side. The first end 221, distributed along the first direction (for example, the x-direction), of the second radiators 22 retracts relative to the first end 211 of the first radiator 21 on the same side, and the second end 222, distributed along the first direction (for example, the x-direction), of the second radiator 22 extends outward relative to the second end 212 of the first radiators 21 on the same side.

To improve strength of the first antenna structure, gaps formed by the first antenna structure may be filled with insulting media (for example, plastic), to form a medium layer.

For example, the first gap 323 between the first radiator 21 and the ground plane 30 may be filled with an insulting medium (for example, plastic) to improve strength of the first antenna structure. As shown in FIG. 9, a shadow part at the first gap 323 is a medium part filled in the first gap 323.

In an embodiment in which the first radiator 21 is a metal bezel antenna of the electronic device, for example, the gap 321 and the gap 322 are filled with an insulting medium layer (for example, plastic) to improve strength of the first antenna structure. As shown in FIG. 9, shadow parts at the gap 321 and the gap 322 are medium parts filled in the two gaps.

For example, the second gap 324 between the second radiator 22 and the ground plane 30 may also be filled with a medium. The medium formed herein may be used as an antenna holder 24 (for example, the antenna holder 24 shown in FIG. 11 and FIG. 12) of the second radiator 22 to perform a supporting function. The second radiator 22 is supported on the ground plane 30 by using the antenna holder 24.

To better implement energy coupling between the first radiator 21 and the second radiator 22, projections of the first radiator 21 and the second radiator 22 in a plane (for example, the xz plane) formed by the first direction (for example, the x-direction) and the second direction (for example, the z-direction) at least partially overlap. It should be understood that “at least partially overlap” herein indicates that the two projections share any overlapping region on a projection plane.

FIG. 15 is a schematic diagram of projections of a first radiator and a second radiator on a projection plane according to an embodiment of this application.

In some embodiments, the projections of the first radiator 21 and the second radiator 22 in the plane (for example, the xz plane) formed by the first direction (for example, the x-direction) and the second direction (for example, the z-direction) partially overlap. In an example, refer to (a) and (b) in 15, a region in which a projection 21′ of the first radiator 21 and a projection 22′ of the second radiator 22 overlap is an entire projection of the second radiator 22. In another example, refer to (c) in FIG. 15, a region in which the two projections overlap may alternatively be a partial projection of the second radiator 22.

In some other embodiments, refer to (d) in FIG. 15. The projections of the first radiator 21 and the second radiator 22 in the plane (for example, the xz plane) formed by the first direction (for example, the x-direction) and the second direction (for example, the z-direction) completely overlap.

In embodiments of this application, the first radiator 21 and the second radiator 21 may be structures of any shape. This is not limited. For example, the first radiator 21 and/or the second radiator 22 may have a square-shaped (for example, rectangular, square) structure, an irregularly-shaped (for example, L-shaped, T-shaped) structure, or a curved (for example, circular, elliptical, U-shaped) structure.

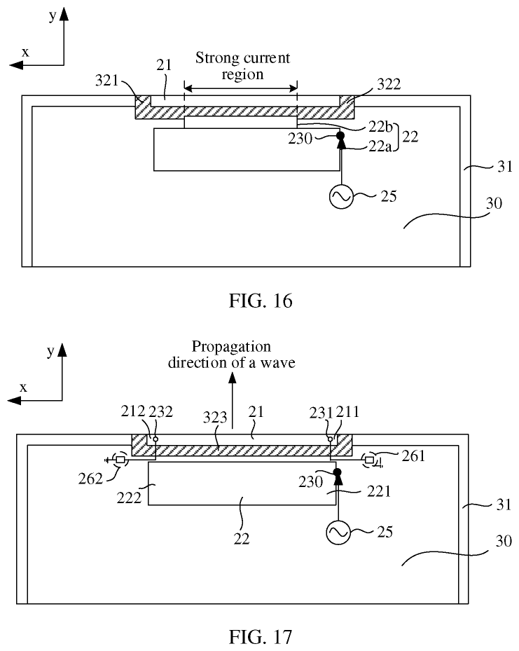

FIG. 16 is another schematic diagram of a local region near a first antenna structure in an electronic device according to an embodiment of this application.

An example in which the feed point 230 is disposed at the first end of the second radiator 22 is used. Refer to FIG. 16, the second radiator 22 includes a main body portion 22a and a protrusion portion 22b, the protrusion portion 22b is disposed in a middle region of the main body portion 22a, and the protrusion portion 22b protrudes outward from the main body portion 22a in a direction toward the first radiator 21. It may be understood that a region (referred to as a recessed region) in which no protrusion portion 22b is provided and that is on a surface, facing the first radiator 21, of the main body portion 22a is recessed relative to the protrusion portion 22b. The middle region of the main body portion 22a described herein may be a region extending a part from a midpoint of the main body portion 22a to two sides, and is not necessarily a middle position in absolute physical sense.

For a structure in which the first radiator 21 and the second radiator 22 radiate an electromagnetic wave through energy coupling, generally, during energy coupling, middle regions of the two radiators in a length direction are strong current regions, and current in the regions is high, and regions on both sides of the regions are weak current regions. A protrusion portion 22b that protrudes outward toward the first radiator 21 is disposed in a middle region of the main body portion 22a of the second radiator 22. The protrusion portion 22b is closest to the first radiator 21 in the third direction (for example, the y-direction), and a region in which the protrusion portion 22a is located is a strong current region in which the two radiators perform energy coupling. Therefore, this structure can effectively improve coupling performance of the first radiator 21 and the second radiator 22.

It should be understood that in addition to the radiators, the first antenna structure may further include components such as a feed source, medium layers closely connected to the radiators, and/or components such as various matching circuits electrically connected to the radiator. This is not limited.

In the foregoing embodiments, the first antenna structure may further include a matching circuit. The matching circuit may be disposed at different positions on the first radiator 21 and/or the second radiator 22, and is configured to: tune the first antenna structure and/or control a circularly polarized component, so that the first antenna structure achieves good antenna performance, and formation of circularly polarized waves is facilitated.

As described above, because circular polarization of an electromagnetic wave is classified into left-handed circular polarization and right-handed circular polarization, there is a slight difference in designs of circular polarization in different directions. For example, when the feed point 230 is disposed at the first end 221 of the second radiator 22 or disposed at the first end 211 of the first radiator 21, it is beneficial to formation of a left-handed circularly polarized wave of the first antenna structure, and can improve left-handed circular polarization of the first antenna structure. With reference to the foregoing descriptions, using an example in which the feed point 230 is disposed at the first end 221 of the second radiator 22, the matching circuit is described from a perspective of improving left-handed circular polarization performance of the first antenna structure. It should be understood that, for a design of the matching circuit when the feed point 230 is disposed at the first radiator 21, refer to related descriptions below. Details are not described again.

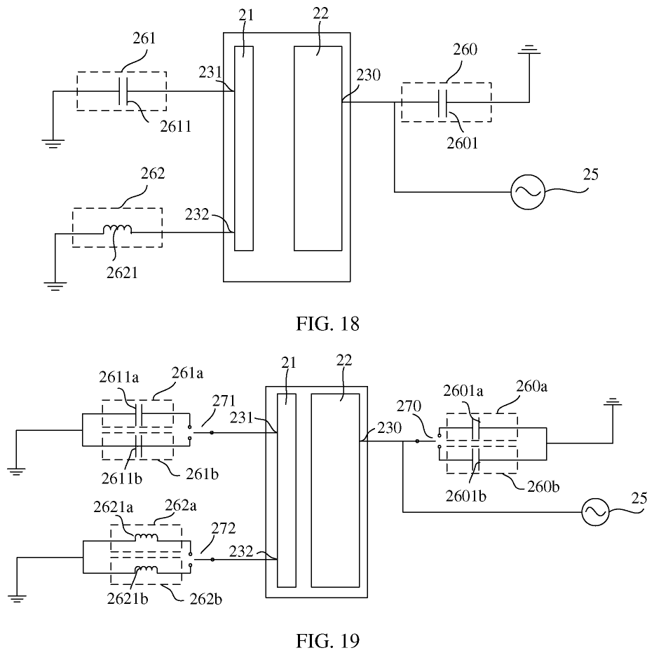

FIG. 17 is another schematic diagram of a local region near a first antenna structure in an electronic device according to an embodiment of this application. FIG. 18 is a schematic diagram of a matching circuit according to an embodiment of this application. FIG. 19 is another schematic diagram of a matching circuit according to an embodiment of this application.

In some embodiments, a matching circuit that is grounded is disposed on the first radiator 21, and the matching circuit is configured to match an operating frequency of the first antenna structure. In addition, in some scenarios, the matching circuit may be further configured to control a left-handed circularly polarized component of the first antenna structure.

In some embodiments, refer to FIG. 17. The first end 221 of the second radiator 22 is provided with the feed point 230, and the first radiator 21 includes two ports: a first port 231 and a second port 232. A first matching circuit 261 that is grounded is disposed at the first port 231. A second matching circuit 262 that is grounded is disposed at the second port 232. The first matching circuit 261 and the second matching circuit 262 are jointly configured to match the operating frequency of the first antenna structure, and may further be configured to control the left-handed circularly polarized component of the first antenna structure. For example, the first port 231 is located at the first end 211 of the first radiator 21, and the second port 232 is located at the second end 212 of the first radiator 21. Herein, the first port 231 and the feed point 230 are disposed on a same side of the first antenna structure.

For example, refer to FIG. 18. The first matching circuit 261 includes a capacitor 2611, one end of the capacitor 2611 is electrically connected to the first radiator 21 at the first port 231, and the other end of the capacitor 2611 is grounded. The second matching circuit 262 includes an inductor 2621, one end of the inductor 2621 is electrically connected to the first radiator 21 at the second port 232, and the other end of the inductor 2621 is grounded. Such a structural design facilitates the formation of the left-handed circularly polarized wave of the first antenna structure.

In the foregoing embodiments, the capacitor and the inductor may be configured to adjust phase lead or lag. From a perspective of improving left-handed circular polarization performance of the first antenna structure, the first port 231 is disposed at the first end 211 of the first radiator 21 and the second port 232 is disposed at the second end 212 of the first radiator 21. The first matching circuit 261 at the first port 231 includes the capacitor 2611, and the second matching circuit 262 at the second port 232 includes the inductor 2621. In this way, a phase difference between two perpendicular and orthogonal electric field components (for example, electric field components distributed along the x-direction and the z-direction) generated by the first antenna structure is closer to a requirement for a phase difference of left-handed circular polarization. To be specific, a phase of the electric field component distributed along the x-direction lags by 90° relative to a phase of the electric field component distributed along the z-direction. In this way, the first matching circuit 261 and the second matching circuit 262 can better control a left-handed circularly polarized component of the first antenna structure when being able to match the operating frequency of the first antenna structure. This facilitates formation of the left-handed circularly polarized wave of the first antenna structure, obtains better left-handed circular polarization directivity, and improves circular polarization performance of the first antenna structure. In addition, the feed point 230 is disposed at the first end 221 of the second radiator 22, and both the feed point 230 and the capacitor 2611 are located on the same side of the first antenna structure. This more facilitates the formation of the left-handed circularly polarized wave, thereby improving the circular polarization performance of the first antenna structure.

It should be understood that the matching circuit on the first radiator 21 in the above example is for illustrative purposes only and should not be construed as limiting embodiments of this application. This application imposes no limitation on a form of the matching circuit.

For example, the first matching circuit 261 and the second matching circuit 262 may also be in other forms, and achieve a same objective by using a combination of a capacitor, an inductor, and other electronic components.

For another example, a matching circuit does not need to be disposed at both of the two ports of the first radiator 21. For example, a matching circuit may be disposed at either of the first port 231 and the second port 232, and is configured to match the operating frequency of the first antenna structure, and may further be configured to control the left-handed circularly polarized component. A form of the matching circuit is not limited.

In some embodiments, refer to FIG. 18. A third matching circuit 260 may be disposed at the feed point 230, to match the operating frequency of the first antenna structure.

In an example, still refer to FIG. 18. The third matching circuit 260 is grounded, and is connected in parallel to a feed path between the feed point 230 and a feed source 25. For example, the third matching circuit 260 includes a capacitor 2601. One end of the capacitor 2601 is electrically connected to the second radiator 22 at the feed point 230, and the other end of the capacitor 2601 is grounded. In this design, the operating frequency of the first antenna structure can be matched by using a minimum quantity of electronic components.

In another example (not shown in the figure), the third matching circuit 260 may alternatively be connected in series to a feed path between the feed point 230 and a feed source 25.

In a specific example, the feed point 230 is disposed at the first end 221 of the second radiator 22, the first matching circuit 261 that is grounded is disposed at the first port 231 of the first radiator 21, the second matching circuit 262 that is grounded is disposed at the second port 232 of the first radiator 21, and the third matching circuit 260 is disposed at the feed point 230. The first matching circuit 261 includes the capacitor 2611, one end of the capacitor 2611 is electrically connected to the first radiator 21 at the first port 231, and the other end of the capacitor 2611 is grounded. The second matching circuit includes the inductor 2621, one end of the inductor 2621 is electrically connected to the first radiator 21 at the second port 232, and the other end of the inductor 2621 is grounded. The third matching circuit 260 includes the capacitor 2601, one end of the capacitor 2601 is electrically connected to the second radiator 22 at the feed point 230, and the other end of the capacitor 2601 is grounded. Such a structural design facilitates the formation of the left-handed circularly polarized wave of the first antenna structure.

In embodiments of this application, a switch may further be disposed at each port or feed point of the radiator, and the switch is configured for switching between a plurality of matching circuits, to adjust the first antenna structure to different operating frequencies and/or to different states of other parameters (for example, a rotation direction of circular polarization and an axis ratio of circular polarization).

In some embodiments, refer to FIG. 19. A switch 271 is disposed at the first port 231 of the first radiator 21. A plurality of matching circuits grounded are included between the switch 271 and the ground. For example, the plurality of matching circuits include a matching circuit 261a and a matching circuit 261b. The switch 271 may switch between the matching circuit 261a and the matching circuit 261b, to switch the first radiator 21 to different operating frequencies. For example, when the switch 271 is electrically connected to the matching circuit 261a, an operating frequency of the first radiator 21 is 2.2 Ghz; and when the switch 271 is electrically connected to the matching circuit 261b, the operating frequency of the first radiator 21 is 2.0 Ghz. For example, the matching circuit 261a includes a capacitor 2611a, and the matching circuit 261b includes a capacitor 2611b. It should be understood that the first matching circuit 261 in FIG. 18 may be the matching circuit 261a or the matching circuit 261b herein.

In some embodiments, still refer to FIG. 19. A switch 272 is disposed at the second port 232 of the first radiator 21. A plurality of matching circuits are included between the switch 272 and the. For example, the plurality of matching circuits include a matching circuit 262a and a matching circuit 262b. The switch 272 may switch between the matching circuit 262a and the matching circuit 262b, to switch the first radiator 21 to different operating frequencies. For example, when the switch 272 is electrically connected to the matching circuit 262a, an operating frequency of the first radiator 21 is 2.2 Ghz; and when the switch 272 is electrically connected to the matching circuit 262b, the operating frequency of the first radiator 21 is 2.0 Ghz. For example, the matching circuit 262a includes an inductor 2621a, and the matching circuit 262b includes a capacitor 2621b. It should be understood that the second matching circuit 262 in FIG. 18 may be the matching circuit 262a or the matching circuit 262b herein.

In some embodiments, still refer to FIG. 19. A switch 270 is disposed at the feed point 230 of the second radiator 22. A plurality of matching circuits are included between the switch 270 and the. For example, the plurality of matching circuits include a matching circuit 260a and a matching circuit 260b. The switch 270 may switch between the matching circuit 260a and the matching circuit 260b, to switch the second radiator 22 to different operating frequencies. For example, when the switch 270 is electrically connected to the matching circuit 260a, an operating frequency of the second radiator 21 is 2.2 Ghz; and when the switch 270 is electrically connected to the matching circuit 260b, the operating frequency of the second radiator 21 is 2.0 Ghz. It should be understood that the third matching circuit 260 in FIG. 18 may be the matching circuit 260a or the matching circuit 260b herein.

It should be noted that when the first port 231, the second port 232, and the feed point 230 are all switched between different matching circuits via switches, the matching circuits connected to the first port 231, the second port 232, and the feed point 230 through the switches enable the first radiator 21 and the second radiator 22 to operate at a same operating frequency.

When the feed point 230 is disposed at the first end 211 of the first radiator 21, for a design of the matching circuit, refer to the foregoing matching circuit. For example, the first end 221 of the second radiator 22 includes the first port 231, and the second end 222 of the second radiator 22 is provided with the second port 232. The first matching circuit 261 grounded is disposed at the first port 231, the second matching circuit 262 grounded is disposed at the second port 232, and the third matching circuit 260 is disposed at the feed point 230. The feed point 230 and the first port 231 are located on the same side of the first antenna structure. For descriptions of the various matching circuits, refer to the detailed descriptions provided above. Details are not described again.

It should be understood that the foregoing illustrative matching circuit is merely an example and should not be construed as a limitation on embodiments of this application. A matching circuit in another form may further be configured on each port or feed point, provided that a same effect is achieved. For example, a corresponding objective may be achieved by using any combination of a capacitor and/or an inductor and other electronic components.

It should be further understood that the foregoing ports and/or feed points may not be provided with a matching circuit. For example, an electrical length of a radiator may be adjusted to achieve a tuning objective.

As described above, the first antenna structure in embodiments of this application may be used in satellite communication. The operating frequency of the first antenna structure may be a satellite frequency band of any frequency. For a handheld device such as a mobile phone, a tablet computer, or a notebook computer, for example, the operating frequency of the first antenna structure may be 2.2 Ghz, 2.0 Ghz, an L-band, an S-band, or another frequency in a range of 1 Ghz to 4 Ghz. This is not limited in embodiments of this application.

For satellite communication, with reference to a habit of using an electronic device by a user, for example, the first antenna structure may be disposed on a top end of the electronic device. As shown in FIG. 9, FIG. 10, and FIG. 14, a position at which the first antenna structure is located is the top end of the electronic device, and the position is a part in a positive y-direction of the electronic device. In this way, when the user holds the electronic device in a normal manner, the first antenna structure located on the top end of the mobile phone is less likely to be blocked by a hand. This does not cause additional impact on the performance of the first antenna structure.

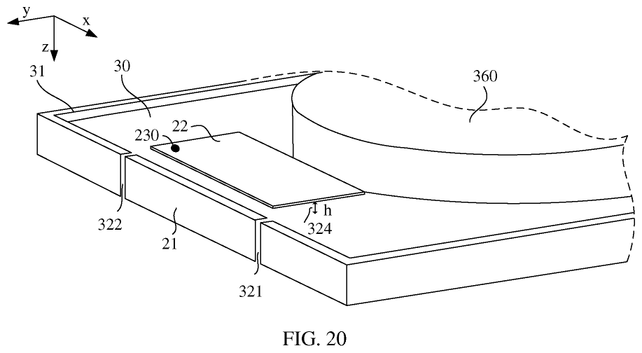

Usually, a camera is disposed at the top end of the electronic device, for example, a front camera and/or a rear camera. A USB port is usually disposed at a bottom end opposite to the top end of the electronic device. FIG. 20 is another schematic diagram of a local region near a first antenna structure in an electronic device according to an embodiment of this application. Refer to FIG. 20. A rear camera 360 is disposed at the top end of the electronic device, the first antenna structure is disposed on a side of the rear camera 360, and the second radiator 22 is disposed between the first radiator 21 and the rear camera 360.

When performing simulation on performance of the first antenna structure, due to close proximity of the rear camera 360 to the second radiator 22, the electronic device shown in FIG. 20 is used an example to conduct the simulation on the performance of the first antenna structure to obtain a relatively accurate simulation result for the first antenna structure. In addition, the feed point 230 in FIG. 20 is disposed at the first end 221 of the second radiator 22, and left-handed circular polarization performance of the first antenna structure is focused.

With reference to FIG. 20 to FIG. 24, the following further describes results of left-handed circular polarization performance of the first antenna structure through simulation results according to embodiments of this application.

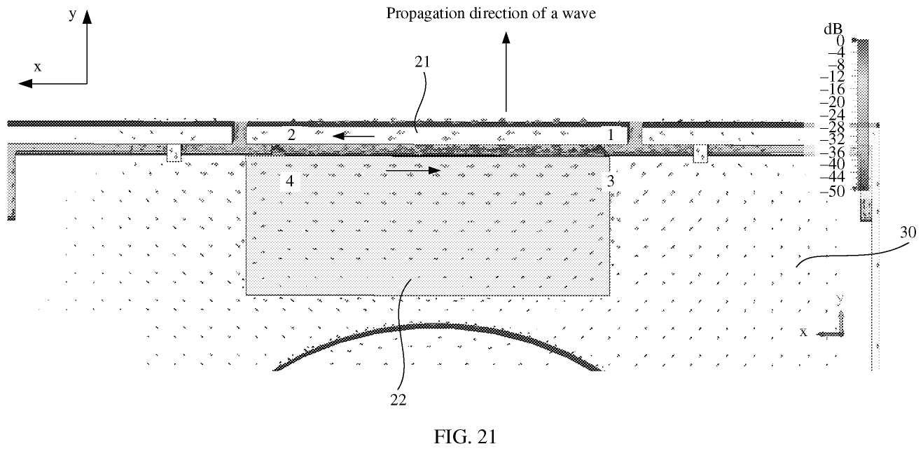

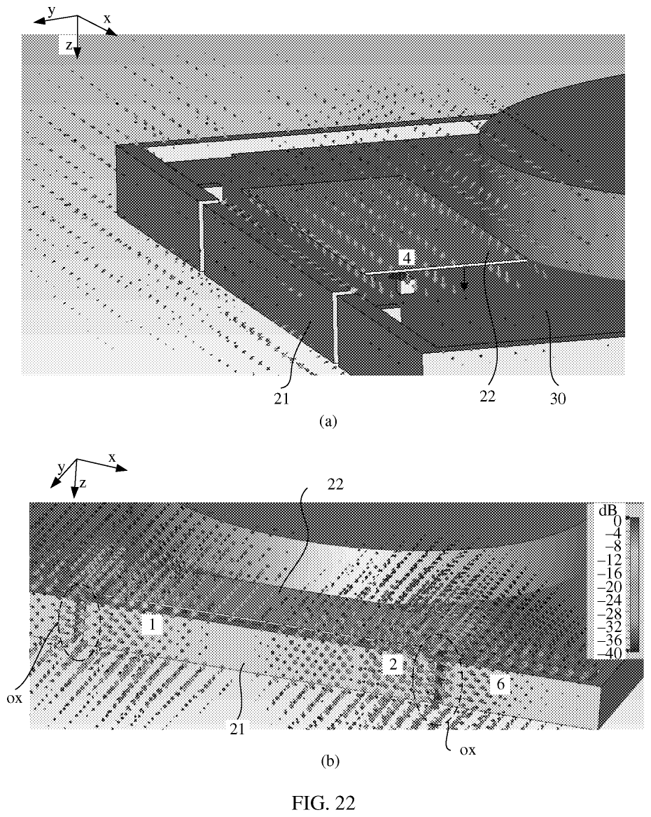

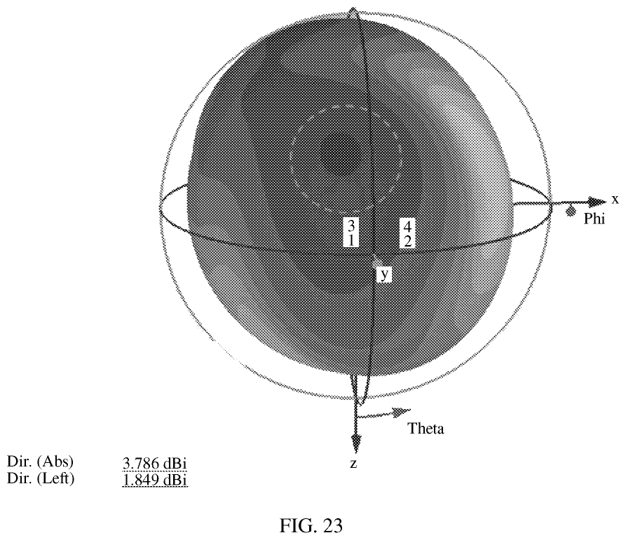

FIG. 21 to FIG. 23 are diagrams showing a simulation result of a first antenna structure when an operating frequency of the first antenna structure is 2.2 Ghz. FIG. 21 is a current distribution diagram of a local region near a first antenna structure in the electronic device shown in FIG. 20, when an operating frequency of the first antenna structure is 2.2 Ghz. FIG. 22 is a distribution diagram of an electric field in a local region near a first antenna structure in the electronic device shown in FIG. 20, when an operating frequency of the first antenna structure is 2.2 Ghz according to an embodiment of this application. (a) and (b) in FIG. 22 are electric field distribution diagrams at two viewing angles. FIG. 23 is a diagram of left-handed circular polarization directivity of the electronic device shown in FIG. 20 when an operating frequency of the first antenna structure is 2.2 Ghz.

In the 2.2 Ghz simulation structure of the first antenna structure shown in FIG. 20, in a specific example, physical lengths of the first radiator 21 and the second radiator 22 may be 32 mm, which is close to a quarter of an operating wavelength, the gap 321, the gap 322, and the first gap 323 are 1.2 mm, and the second gap 324 is 2 mm. A matching circuit of the first radiator 21 and the second radiator 22 is shown in FIG. 18. A capacitance value of the capacitor 2611 is 2.4 pF, an induction value of the inductor 2621 is 7 nH, and a capacitance value of the capacitor 2601 is 4.2 pF.

In FIG. 21, on a top end of the positive y-direction of the electronic device, current is distributed on both the first radiator 211 and the second radiator 22, and the first antenna structure generates radiation.

In FIG. 22, for an electromagnetic wave generated by the first antenna structure and whose propagation direction is the positive y-direction, an electric field component distributed along the x-direction (shown in a dashed region ox in (b) in FIG. 22) and an electric field component distributed along the z-direction (shown in (a) in FIG. 22) are formed. With regard to the electric field component in the z-direction that is focused on, it can be learned from (a) in FIG. 22 that, the electric field component distributed along the z-direction is formed between the second radiator 22 and the ground plane 30, and the entire second radiator 22 provides a large quantity of electric field components distributed along the z-direction.

General directivity and left-handed circular polarization directivity of the electronic device are displayed in the diagram of the left-handed circular polarization directivity in FIG. 23. For left-handed circular polarization directivity of a directional range (a region marked by a dashed circle) that is focused on and that is for receiving and sending a left-handed circularly polarized wave, a direction in which the left-handed circular polarization directivity of the electronic device is located is in the region marked by the dashed circle. Therefore, the left-handed circular polarization directivity of the electronic device shown in FIG. 23 may be used as the left-handed circular polarization directivity of the directional range that is focused on and marked by the dashed circle and that is for receiving and sending the left-handed circularly polarized wave. Based on this, the left-handed circular polarization directivity of the first antenna structure obtained in the simulation result in FIG. 23 is 1.849 dBi.

Comparison is performed between FIG. 23 and FIG. 7. When radiation efficiency of the two antenna structures is basically the same, the left-handed circular polarization directivity of the antenna structure in the existing technology is 0.9625 dBi, and the left-handed circular polarization directivity of the first antenna structure in embodiments of this application is 1.849 dBi, which is improved by 0.8865 dBi compared with the left-handed circular polarization directivity of the antenna structure in the existing technology. Therefore, a circularly polarized wave can be better formed. Compared with the existing technology, this application significantly effectively improves circular polarization performance of the antenna structure.

In the 2.0 Ghz simulation structure of the first antenna structure shown in FIG. 20, a size of the first antenna structure remains unchanged, and a matching circuit is slightly changed. A matching circuit of the first radiator 21 and the second radiator 22 is similar to that in FIG. 18. A capacitance value of the capacitor 2611 is 2.4 pF, and both the inductor 2621 and the capacitor 2601 are open-circuited.

Because phenomena of current distribution and electric field distribution when the operating frequency of the first antenna structure is 2.0 Ghz are basically similar to those of current distribution and electric field distribution when the operating frequency of the first antenna structure is 2.2 Ghz, the current distribution and the electric field distribution when the operating frequency is 2.0 Ghz are not described herein again. For details, refer to related descriptions provided when the operating frequency of the first antenna structure is 2.2 Ghz.

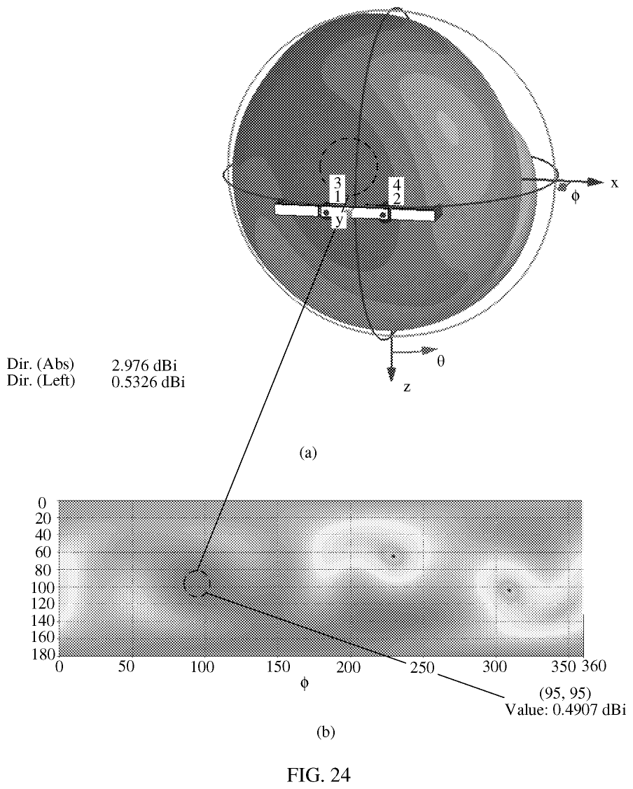

FIG. 24 is a diagram of left-handed circular polarization directivity of the electronic device shown in FIG. 20 when an operating frequency of the first antenna structure is 2.0 Ghz. (a) in FIG. 24 is a diagram of a left-handed circular polarization direction in a spherical coordinate system, and (b) in FIG. 24 is a diagram of a left-handed circular polarization direction in a two-dimensional coordinate system.

For the left-handed circular polarization directivity within the directional range of interest that is for receiving and sending the left-handed circularly polarized wave and that is marked by the dashed circle, a direction in which the left-handed circular polarization directivity of the electronic device shown at the lower left corner of the left-handed circular polarization directivity diagram in (a) in FIG. 24 is located is not within the directional range of interest that is marked by the dashed circle. Therefore, the directional range of interest that is marked by the dashed circle is found in (b) in FIG. 24, and a maximum left-handed circular polarization directivity within the directional range is used as a left-handed circular polarization directivity of the directional range. The maximum left-handed circular polarization directivity is 0.4907 dBi, and coordinates of the maximum left-handed circular polarization direction are (φ=95°, θ=95°). In other words, the left-handed circular polarization directivity of the first antenna structure obtained in the simulation result in FIG. 24 is 0.4907 dBi.

Comparison is performed between FIG. 24 and FIG. 8. When radiation efficiency of the two antenna structures is basically the same, the left-handed circular polarization directivity of the antenna structure in the existing technology is-0.6411 dBi, and the left-handed circular polarization directivity of the first antenna structure in embodiments of this application is 0.4907 dBi, which is improved by 1.1318 dBi compared with the left-handed circular polarization directivity of the antenna structure in the existing technology. Therefore, a circularly polarized wave can be better formed. Compared with the existing technology, this application significantly effectively improves circular polarization performance of the antenna structure.

The first antenna structure is described above mainly from the perspective of improving the left-handed circular polarization performance of the antenna structure. With reference to FIG. 25 to FIG. 33, the first antenna structure in embodiments of this application is described below from a perspective of improving the right-handed circular polarization performance of the antenna structure. A main difference between the first antenna structure used for improving the right-handed circular polarization performance and the foregoing first antenna structure used for improving the left-handed circular polarization performance lies in disposition of a feed point and disposition of a related matching circuit. Remaining structures are basically similar. Therefore, only the difference between the two is described emphatically below. For descriptions of the similar structures, refer to the foregoing related descriptions.

FIG. 25 is another schematic diagram of a local region near a first antenna structure in an electronic device according to an embodiment of this application. FIG. 26 is another three-dimensional schematic diagram of a local region near a first antenna structure in an electronic device according to an embodiment of this application. FIG. 27 is another schematic diagram of a local region near a first antenna structure in an electronic device according to an embodiment of this application.

Refer to FIG. 25 and FIG. 26. The first radiator 21 of the first antenna structure is disposed on a side of the ground plane 30, and a first gap 323 is spaced between the first radiator 21 of the first antenna structure and the ground plane 30. The second radiator 22 is disposed above and parallel to the ground plane 30, and a second gap 324 is spaced between the second radiator 22 and the ground plane 30 (shown in FIG. 26). The first radiator 21 and the second radiator 22 are mutually non-contacting. For example, a length direction of the first radiator 21 is parallel to a length direction of the second radiator 22. At least one feed point 230 is disposed on at least one of the first radiator 21 and the second radiator 22. When feeding is performed at the feed point 230, the first radiator 21 and the second radiator 22 operate at a same operating frequency. In this way, energy coupling can be performed between the first radiator 21 and the second radiator 22 to radiate an electromagnetic wave.

In some embodiments, the feed point 230 is disposed on the second radiator 22. The second radiator 22 has two end portions: a first end 221 and a second end 222, distributed along the first direction (for example, the x-direction). For example, the feed point 230 is disposed at the second end 222 of the second radiator 22, that is, the feed point 230 is disposed at an end portion, located in a positive x-direction, of the second radiator 22. It may be understood that such a disposing manner is beneficial to adjusting a phase difference between two perpendicular and orthogonal electric field components (for example, electric field components in the x-direction and the z-direction) generated by the first antenna structure, so that the phase difference satisfies a phase requirement of right-handed circular polarization, and is beneficial to forming a right-handed circularly polarized wave.

In some other embodiments, refer to FIG. 27. The feed point 230 is disposed on the first radiator 21. The first radiator 21 has two end portions: a first end 211 and a second end 212, distributed along the first direction (for example, the x-direction). For example, the feed point 230 is disposed at the second end 212 of the first radiator 21, that is, the feed point 230 is disposed at an end portion, located in a positive x-direction, of the first radiator 21. Such a disposing manner is beneficial to forming a right-handed circularly polarized wave.

It may be understood that disposing the feed point 230 at the second end 212 of the first radiator 21 or at the second end 222 of the second radiator 22 is beneficial to adjusting a phase difference between two perpendicular and orthogonal electric field components (for example, electric field components in the x-direction and the z-direction) generated by the first antenna structure, so that the phase difference satisfies a phase requirement of right-handed circular polarization. To be specific, a phase of the electric field component distributed along the first direction (for example, the x-direction) leads that of the electric field component distributed along the second direction (for example, the z-direction) by 90°, which is beneficial to forming a right-handed circularly polarized wave.

An example in which the second end 222 of the second radiator 22 is provided with the feed point 230 is used. In some embodiments, a matching circuit that is grounded is disposed on the first radiator 21, and the matching circuit is configured to match an operating frequency of the first antenna structure. In addition, in some scenarios, the matching circuit may further be configured to control a right-handed circularly polarized component of the first antenna structure.

FIG. 28 is another schematic diagram of a local region near a first antenna structure in an electronic device according to an embodiment of this application.

In some embodiments, refer to FIG. 28. The first radiator 21 includes two ports: a first port 231 and a second port 232. A first matching circuit 261 that is grounded is disposed at the first port 231. A second matching circuit 262 that is grounded is disposed at the second port 232. The first matching circuit 261 and the second matching circuit 262 are configured to match the operating frequency of the first antenna structure, and may further be configured to control the right-handed circularly polarized component of the first antenna structure. For example, the first port 231 is located at the second end 212 of the first radiator 21, and the second port 232 is located at the first end 211 of the first radiator 21. Herein, the first port 231 and the feed point 230 are disposed on a same side of the first antenna structure.

In some embodiments, a third matching circuit 260 (shown in FIG. 18) may be disposed at the feed point 230, to match the operating frequency of the first antenna structure.

For related descriptions about the first matching circuit 261, the second matching circuit 262, and the third matching circuit 260, refer to the related descriptions about FIG. 18 above. Details are not described again.

In the foregoing embodiments, the capacitor and the inductor may be configured to adjust phase lead or lag. From a perspective of improving right-handed circular polarization of the first antenna structure, the first port 231 is disposed at the second end 212 of the first radiator 21 and the second port 232 is disposed at the first end 211 of the first radiator 21. The first matching circuit 261 at the first port 231 includes the capacitor 2611, and the second matching circuit 262 at the second port 232 includes the inductor 2621. In this way, a phase difference between two perpendicular and orthogonal electric field components (for example, electric field components in the x-direction and the z-direction) generated by the first antenna structure is closer to a requirement for a phase difference of right-handed circular polarization. To be specific, a phase of the electric field component distributed along the x-direction leads by 90° relative to a phase of the electric field component distributed along the z-direction. In this way, the first matching circuit 261 and the first matching circuit 262 can better control a right-handed circularly polarized component of the first antenna structure when being matching the operating frequency of the first radiator 21. This facilitates formation of the right-handed circularly polarized wave of the first antenna structure, obtains better right-handed circular polarization directivity, and improves circular polarization performance of the first antenna structure. In addition, the feed point 230 is disposed at the second end 222 of the second radiator 22, and both the feed point 230 and the capacitor 2611 are located on the same side of the first antenna structure. This more facilitates the formation of the right-handed circularly polarized wave, thereby improving the circular polarization performance of the first antenna structure.

When the feed point 230 is disposed at the second end 212 of the first radiator 21, for a design of the matching circuit, refer to the foregoing matching circuit. For example, the second end 222 of the second radiator 22 includes the first port 231, and the first end 221 of the second radiator 22 is provided with the second port 232. The first matching circuit 261 grounded is disposed at the first port 231, the second matching circuit 261 grounded is disposed at the second port 232, and the third matching circuit 260 is disposed at the feed point 230. For descriptions of the various matching circuits, refer to the detailed descriptions provided above. Details are not described again.

In the foregoing embodiments, switches may further be disposed at the feed point 230, the first port 231, and the second port 232, to perform switching between a plurality of matching circuits, to adjust the first antenna structure to different operating frequencies or to different states of other parameters. For specific descriptions, refer to related descriptions in the embodiment shown in FIG. 19. Details are not described again.

It can be learned that, relative to the first antenna structure configured to improve the left-handed circular polarization performance, locations of the feed point 230, the first port 231, and the second port 232 of the first antenna structure configured to improve the right-handed circular polarization performance, and the first matching circuit 261 at the first port 231, the second matching circuit 261 at the second port 232, and the third matching circuit 260 at the feed point are all switched in a mirror manner, so that right-handed circular polarization of the first antenna structure can be implemented.

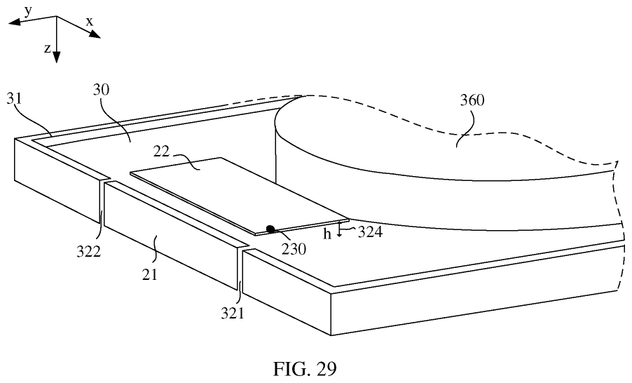

With reference to FIG. 29 to FIG. 33, the following further describes right-handed circular polarization performance of the first antenna structure through simulation results according to embodiments of this application.

FIG. 29 is another three-dimensional schematic diagram of a local region near a first antenna structure in an electronic device according to an embodiment of this application. In FIG. 29, the first antenna structure is disposed on a side of the rear camera 360, and the second radiator 22 is disposed between the first radiator 21 and the rear camera 360.

When performing simulation on performance of the first antenna structure, due to close proximity of the rear camera 360 to the second radiator 22, the electronic device shown in FIG. 29 is used an example to conduct the simulation on the performance of the first antenna structure to obtain a relatively accurate simulation result for the first antenna structure. In addition, the feed point 230 in FIG. 29 is disposed at the second end 222 of the second radiator 22, and right-handed circular polarization performance of the first antenna structure is focused.

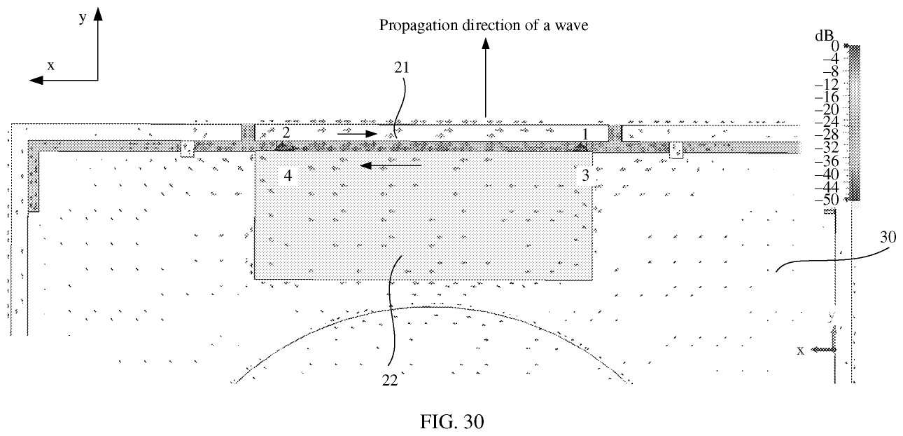

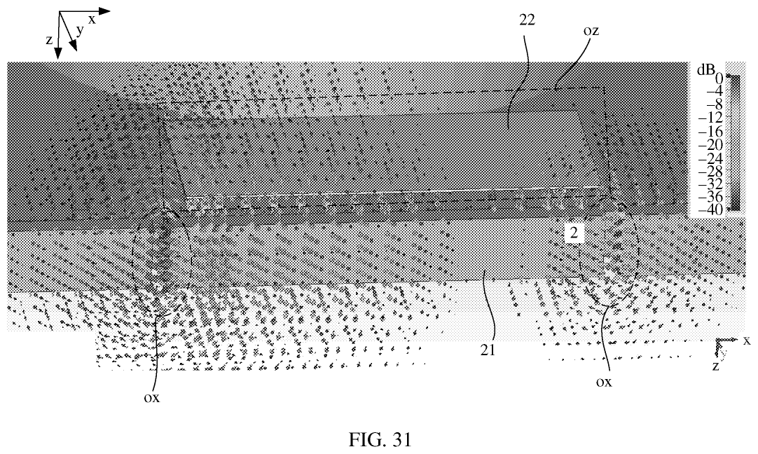

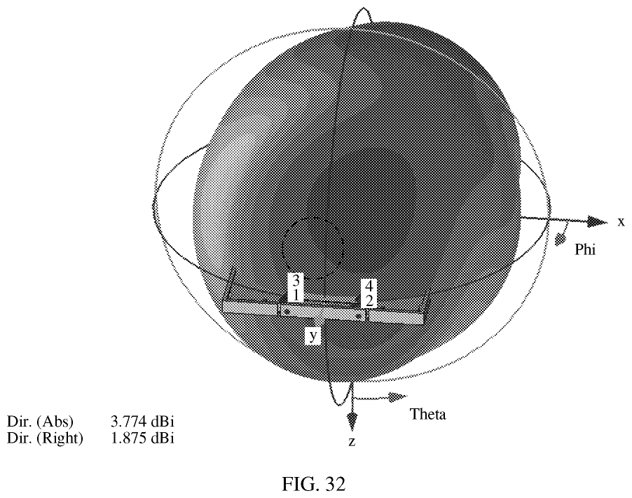

FIG. 30 to FIG. 32 are diagrams showing a simulation result of a first antenna structure when an operating frequency of the first antenna structure is 2.2 Ghz. FIG. 30 is a current distribution diagram of a local region near a first antenna structure in the electronic device shown in FIG. 29, when an operating frequency of the first antenna structure is 2.2 Ghz. FIG. 31 is a distribution diagram of an electric field in a local region near a first antenna structure in the electronic device shown in FIG. 29, when an operating frequency of the first antenna structure is 2.2 Ghz. FIG. 32 is a diagram of right-handed circular polarization directivity of the electronic device shown in FIG. 29 when an operating frequency of the first antenna structure is 2.2 Ghz.

In the 2.2 Ghz simulation structure of the first antenna structure shown in FIG. 29, in a specific example, physical lengths of the first radiator 21 and the second radiator 22 may be 32 mm, which is close to a quarter of an operating wavelength, the gap 321, the gap 322, and the first gap 323 are 1.2 mm, and the second gap 324 is 2 mm. A matching circuit of the first radiator 21 and the second radiator 22 is shown in FIG. 18. A capacitance value of the capacitor 2611 may be 2.4 pF, an induction value of the inductor 2621 may be 7 nH, and a capacitance value of the capacitor 2601 may be 4.2 pF.

In FIG. 30, on a top end of the positive y-direction of the electronic device, current is distributed on both the first radiator 211 and the second radiator 22, and the first antenna structure generates radiation.

In FIG. 31, for an electromagnetic wave generated by the first antenna structure and whose propagation direction is a positive y-direction, an electric field component (shown in a dashed region ox) distributed along the x-direction and an electric field component (shown in a dashed region oz) distributed along the z-direction are formed. For the electric field component distributed along the z-direction, it can be learned from FIG. 31 that, the electric field component distributed along the z-direction is formed between the second radiator 22 and the ground plane 30, and the entire second radiator 22 provides a large quantity of electric field components distributed along the z-direction.

General directivity and right-handed circular polarization directivity of the electronic device are displayed in the diagram of the right-handed circular polarization directivity in FIG. 32. For right-handed circular polarization directivity of a directional range (a region marked by a dashed circle) that is focused on and that is for receiving and sending a right-handed circularly polarized wave, a direction in which the right-handed circular polarization directivity of the electronic device is located is in the region marked by the dashed circle. Therefore, the right-handed circular polarization directivity of the electronic device shown in FIG. 32 may be used as the right-handed circular polarization directivity of the directional range that is focused on and marked by the dashed circle and that is for receiving and sending the right-handed circularly polarized wave. Based on this, the right-handed circular polarization directivity of the first antenna structure obtained in the simulation result in FIG. 32 is 1.8475 dBi.

In the 2.0 Ghz simulation structure of the first antenna structure shown in FIG. 29, a size of the first antenna structure remains unchanged, and a matching circuit is slightly changed. A matching circuit of the first radiator 21 and the second radiator 22 is similar to that in FIG. 18. A capacitance value of the capacitor 2611 is 2.4 pF, and both the inductor 2621 and the capacitor 2601 are open-circuited.

Because phenomena of current distribution and electric field distribution when the operating frequency of the first antenna structure is 2.0 Ghz are basically similar to those of current distribution and electric field distribution when the operating frequency of the first antenna structure is 2.2 Ghz, the current distribution and the electric field distribution when the operating frequency is 2.0 Ghz are not described herein again. For details, refer to related descriptions provided when the operating frequency of the first antenna structure is 2.2 Ghz.

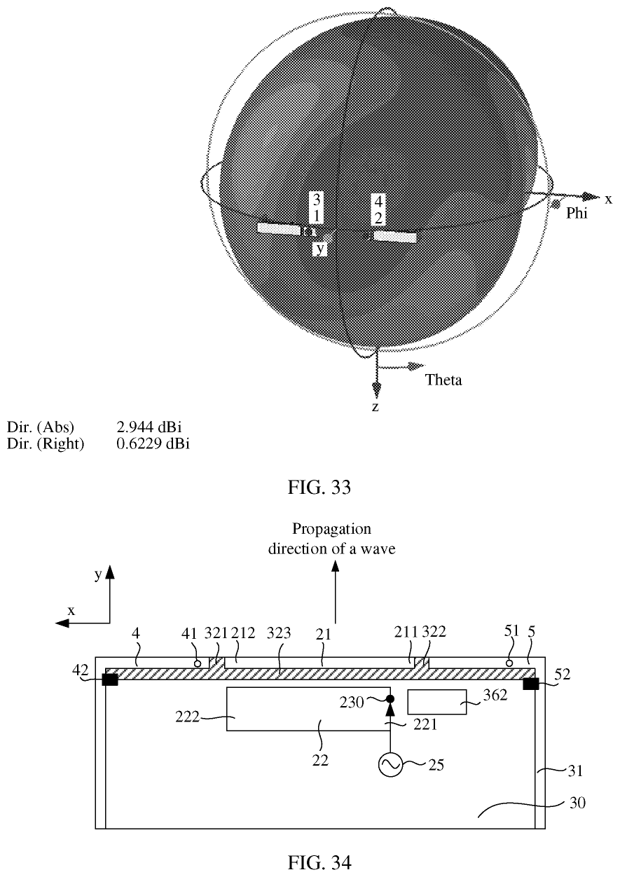

FIG. 33 is a diagram of right-handed circular polarization directivity of the electronic device shown in FIG. 29 when an operating frequency of the first antenna structure is 2.0 Ghz. It may be learned that the right-handed circular polarization directivity of the first antenna structure is 0.6229 dBi.

In embodiments of this application, in addition to the first antenna structure described above, the electronic device may further include another component, for example, include another antenna structure and/or electronic component. Different components may be used in different communication technologies. Because space of the electronic device is limited, different antenna structures affect each other, and other electronic components also affect the design of the antenna structure to some extent. The following embodiments describe a related design of an antenna structure with reference to an environment near the antenna structure in the electronic device. It should be noted that a design of the first antenna structure similar to that of the foregoing first antenna structure is only briefly described. Details are not described again.

In addition, with reference to FIG. 34 to FIG. 43, the first antenna structure in embodiments of this application is first described from a perspective of improving left-handed circular quantization performance. Then, with reference to FIG. 44 to FIG. 52, the first antenna structure in embodiments of this application is described from a perspective of improving right-handed circular quantization performance.

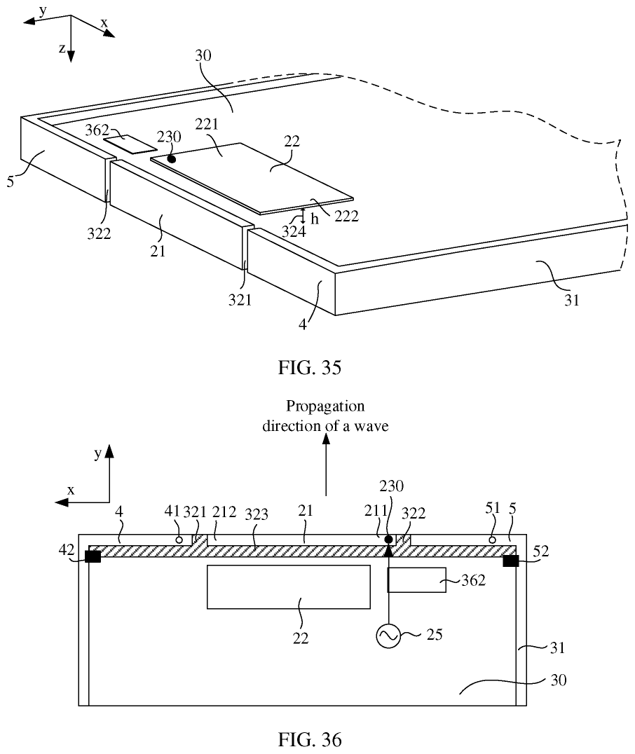

FIG. 34 is another schematic diagram of a local region near a first antenna structure in an electronic device according to an embodiment of this application. FIG. 35 is another three-dimensional schematic diagram of a local region near a first antenna structure in an electronic device according to an embodiment of this application. FIG. 36 is another schematic diagram of a local region near a first antenna structure in an electronic device according to an embodiment of this application.

Refer to FIG. 34 and FIG. 35. The electronic device includes a first antenna structure and a ground plane 30. The first antenna structure includes a first radiator 21 and a second radiator 22. The first radiator 21 is disposed on a side of the ground plane 30, and a first gap 323 is spaced between the first radiator 21 and the ground plane 30. The second radiator 22 is disposed above and parallel to the ground plane 30, and a second gap 324 is spaced between the second radiator 22 and the ground plane 30 (shown in FIG. 35). The first radiator 21 and the second radiator 22 are mutually non-contacting. For example, a length direction of the first radiator 21 is parallel to a length direction of the second radiator 22. At least one feed point 230 is disposed on at least one of the first radiator 21 and the second radiator 22. When feeding is performed at the feed point 230, the first radiator 21 and the second radiator 22 operate at a same operating frequency. In this way, energy coupling can be performed between the first radiator 21 and the second radiator 22 to radiate an electromagnetic wave.

In some embodiments, the feed point 230 is disposed on the second radiator 22. The second radiator 22 has two end portions: a first end 221 and a second end 222, distributed along the first direction (for example, the x-direction). For example, the feed point 230 is disposed at the first end 221 of the second radiator 22, that is, the feed point 230 is disposed at an end portion, located in a negative x-direction, of the second radiator 22. Such a disposing manner is beneficial to forming a left-handed circularly polarized wave.

In some other embodiments, refer to FIG. 36. The feed point 230 is disposed on the first radiator 21. The first radiator 21 has two end portions: a first end 211 and a second end 212, distributed along the first direction (for example, the x-direction). For example, the feed point 230 is disposed at the first end 211 of the first radiator 21, that is, the feed point 230 is disposed at an end portion, located in a negative x-direction, of the first radiator 21. Such a disposing manner is beneficial to forming a left-handed circularly polarized electromagnetic wave.

A related design of the first antenna structure is described below by using an example in which the feed point 230 is disposed at the first end 221 of the second radiator 22. It should be understood that when the feed point 230 is disposed at the first end 211 of the first radiator 21, a related design of the first antenna structure is similar to the following descriptions. Details are not described again.

In some embodiments, still refer to FIG. 34 and FIG. 35. The electronic device further includes a second antenna structure. For example, the second antenna structure may be configured for WIFI communication. The second antenna structure is disposed on a side of the first antenna structure. Specifically, the second antenna structure is disposed on a side of the first radiator 21 in the first antenna structure. The second antenna structure includes a third radiator 4, and a gap 321 is spaced between the third radiator 4 and the first radiator 21.

Herein, the second antenna structure may be disposed on any side of the first radiator 21. In an example, as shown in FIG. 34 and FIG. 35, the second antenna structure is disposed on a side of the second end 212 of the first radiator 21. In another example (not shown in the figure), the second antenna structure is disposed on a side of the first end 211 of the first radiator 21.

The first antenna structure and the second antenna structure may operate simultaneously, or may operate in time division. This is not limited herein. It may be understood that when the first antenna structure and the second antenna structure operate in time division, when the first antenna structure operates, the second antenna structure stops operating, and the second antenna structure may operate on the operating frequency of the first antenna structure as a part of the first antenna structure.

Still refer to FIG. 34. A port 41 and a grounding point 42 are disposed on the third radiator 4. The grounding point 42 is electrically connected to the ground plane 30. For the port 41, in an example, when the second antenna structure operates, the port 41 may be used as a feed point of the second antenna structure, and is configured to feed the second antenna structure. In another example, when the first antenna structure operates, a particular matching circuit may be matched at the port 41, and is configured to serve the first antenna structure. For details, refer to related descriptions about the matching circuit below.

In some embodiments, still refer to FIG. 34 and FIG. 35. The third radiator 4 of the second antenna structure may be a part of the bezel 31 of the electronic device.

In some embodiments, still refer to FIG. 34 and FIG. 35. The electronic device further includes a third antenna structure. For example, the third antenna structure may be configured for LTE communication and/or NR communication. The third antenna structure is disposed on the other side of the first antenna structure. Specifically, the third antenna structure is disposed on the other side of the first radiator 21 in the first antenna structure. That is, the third antenna structure and the second antenna structure are respectively disposed on two sides of the first radiator 21. The second antenna structure includes a fourth radiator 5, and a gap 322 is spaced between the fourth radiator 5 and the first radiator 21.

Herein, the third antenna structure and the second antenna structure are respectively disposed on two sides of the first radiator 21. In an example, as shown in FIG. 34, the second antenna structure is disposed on a side of the second end 212 of the first radiator 21, and the third antenna structure is disposed on a side of the first end 211 of the first radiator 21. In another example (not shown in the figure), the second antenna structure is disposed on a side of the first end 211 of the first radiator 21, and the third antenna structure is disposed on a side of the second end 212 of the first radiator 21.

The first antenna structure and the third antenna structure may operate simultaneously, or may operate in time division. This is not limited herein. It may be understood that when the first antenna structure and the third antenna structure operate in time division, when the first antenna structure operates, the third antenna structure stops operating, and the third antenna structure may operate on the operating frequency of the first antenna structure as a part of the first antenna structure. When the first antenna structure, the second antenna structure, and the third antenna structure operate in time division, when the first antenna structure operates, both the second antenna structure and the third antenna structure stop operating, and the second antenna structure and the third antenna structure may operate on the operating frequency of the first antenna structure as a part of the first antenna structure.

Still refer to FIG. 34. A port 51 and a grounding point 52 are disposed on the fourth radiator 5. The grounding point 52 is electrically connected to the ground plane 30. For the port 51, in an example, when the third antenna structure operates, the port 51 may be used as a feed point of the third antenna structure, and is configured to feed the third antenna structure. In another example, when the first antenna structure operates, a particular matching circuit may be matched at the port 51, and is configured to serve the first antenna structure. For details, refer to related descriptions about the matching circuit below.

In some embodiments, still refer to FIG. 34. The fourth radiator 5 may be a part of the bezel 31 of the electronic device.

In the foregoing embodiments, when the first radiator 21, the third radiator 4, and the fourth radiator 5 are all parts of the bezel 31 of the electronic device, and are all located at a top end of the bezel 31, electrical lengths of the first radiator 21, the third radiator 4, and the fourth radiator 5 may be flexibly set. This is specifically determined according to an actual situation. For example, the second antenna structure and the third antenna structure are existing structures in the electronic device, and the respective electrical lengths of the third radiator 4 and the fourth radiator 5 have been determined to be inconvenient to be modified. In this case, the electrical length of the first radiator 21 is properly adjusted (reduced or increased), and the electrical length of the second radiator 22 is also adjusted based on adjustment of the electrical length of the first radiator 21. In addition, different matching circuits may be incorporated to compensate for impact of the length adjustment. In this way, operating requirements of the antenna structures can be satisfied.

In some embodiments, still refer to FIG. 34 and FIG. 35. The electronic device further includes an electronic component 362. The electronic component 362 is disposed on a side of one end, distributed along the first direction (for example, the x-direction), of the second radiator 22. The end, distributed along the first direction (for example, the x-direction), of the second radiator 22 retracts relative to one end, distributed along the first direction (for example, the x-direction), of the first radiator 21 on a same side. For example, the electronic component 362 is a receiver.

Herein, the end, distributed along the first direction (for example, the x-direction), of the second radiator 22 may be either of the first end 221 and the second end 222 of the second radiator 22. FIG. 34 merely shows a structure in which the electronic component 362 is disposed on a side of the first end 221 that is of the second radiator 22 and that is distributed along the first direction (for example, the x-direction). It should be understood that, the electronic component 362 may alternatively be disposed on a side of the second end 222 that is of the second radiator 22 and that is distributed along the first direction (for example, the x-direction). This is specifically determined according to an actual situation.

Because the electronic component 362 is disposed on a side of one end of the second radiator 22, to avoid the electronic component 362 and enable a relatively clean operating environment near the second radiator 22, one end, distributed along the first direction (for example, the x-direction), of the second radiator 22 retracts relative to one end, distributed along the first direction (for example, the x-direction), of the first radiator 21 on a same side. It should be understood that, the end, distributed along the first direction (for example, the x-direction), of the second radiator 22 and the end, distributed along the first direction (for example, the x-direction), of the first radiator 21 are located on a same side of the first antenna structure. For example, the end, distributed along the first direction (for example, the x-direction), of the second radiator 22 is the first end 221 of the second radiator 22, and the end, distributed along the first direction (for example, the x-direction), of the first radiator 21 is the first end 211 of the first radiator 21.

In the foregoing embodiments, still refer to FIG. 34. When the other end (for example, the second end 212), distributed along the first direction (for example, the x-direction), of the first radiator 21 is flush with the other end (for example, the second end 222), distributed along the first direction (for example, the x-direction), of the second radiator 22, an electrical length (or a physical length) of the second radiator 22 along the first direction (for example, the x-direction) is less than an electrical length (or a physical length) of the first radiator 21 along the first direction (for example, the x-direction). During actual design, if a condition permits, a part of a length may be added to the other end (for example, the second end 222), distributed along the first direction (for example, the x-direction), of the second radiator 22, to compensate for as much as possible a portion that is missing at the end, distributed along the first direction (for example, the x-direction), of the second radiator 22.

In a specific example, as shown in FIG. 34, the electronic component 362 is disposed on a side of the first end 221 of the second radiator 22. The second antenna structure is configured for WIFI communication, and is disposed on a side of the second end 212 of the first radiator 21. The port 41 of the third radiator 4 of the second antenna structure is disposed in proximity to the first radiator 21. The third antenna structure may be configured for LTE communication and/or NR communication, and is disposed on a side of the first end 211 of the first radiator 21. The port 51 of the fourth radiator 5 of the third antenna structure is at a distance from an end portion of the electronic component 362 in the first direction (for example, the x-direction).

It may be understood that, because the electronic component 362 is disposed on a side of the first end 221 of the second radiator 22, the fourth radiator 5 is disposed on a side of the first end 211 of the first radiator 21, and the first end 221 of the second radiator 22 is disposed on a same side as the first end 211 of the first radiator 21, a distance between the fourth radiator 5 and the electronic component 362 is close. To reduce performance impact of the electronic component 362 on the third antenna structure, the port 51 of the fourth radiator 5 of the third antenna structure is disposed far away from the electronic component 362, that is, the port 51 is at the distance from the end portion of the electronic component 362 in the first direction (for example, the x-direction).

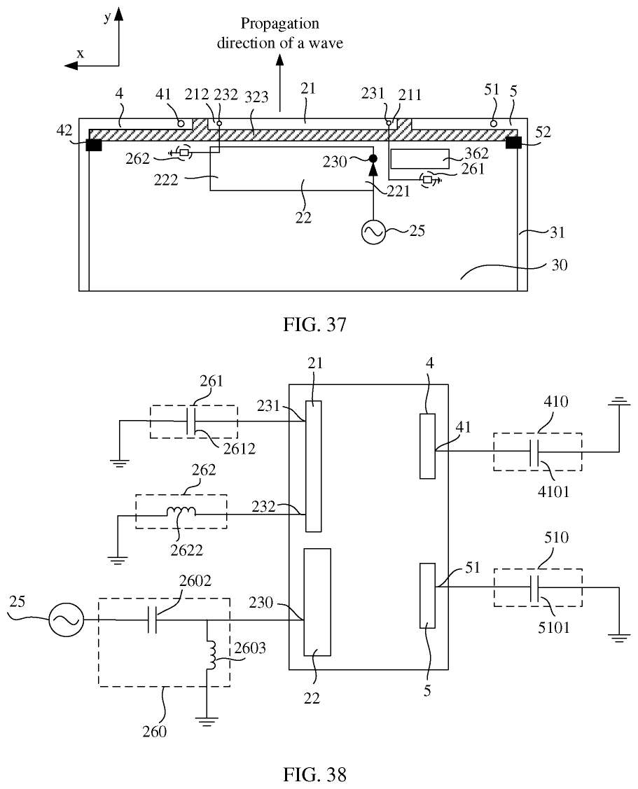

FIG. 37 is another schematic diagram of a local region near a first antenna structure in an electronic device according to an embodiment of this application. FIG. 38 is another schematic diagram of a matching circuit according to an embodiment of this application.

Refer to FIG. 37. The first end 221 of the second radiator 22 is provided with the feed point 230, and the first radiator 21 includes two ports: a first port 231 and a second port 232. A first matching circuit 261 that is grounded is disposed at the first port 231. A second matching circuit 262 that is grounded is disposed at the second port 232. The first matching circuit 261 and the second matching circuit 262 are jointly configured to match the operating frequency of the first antenna structure, and may further be configured to control the left-handed circularly polarized component of the first antenna structure. For example, the first port 231 is located at the first end 211 of the first radiator 21, and the second port 232 is located at the second end 212 of the first radiator 21. Herein, the first port 231 and the feed point 230 are disposed on a same side of the first antenna structure.

For example, refer to FIG. 38. The first matching circuit 261 includes a capacitor 2612, one end of the capacitor 2612 is electrically connected to the first radiator 21 at the first port 231, and the other end of the capacitor 2612 is grounded. The second matching circuit 262 includes an inductor 2622, one end of the inductor 2622 is electrically connected to the first radiator 21 at the second port 232, and the other end of the inductor 2622 is grounded. Such a structural design facilitates the formation of the left-handed circularly polarized wave of the antenna structure.

In some embodiments, still refer to FIG. 38. A third matching circuit 260 may be disposed at the feed point 230, to match the operating frequency of the first antenna structure.

For example, still refer to FIG. 38. The third matching circuit 260 includes an inductor 2603 grounded, and the inductor 2603 is connected in parallel to the feed path between the feed point 230 and the feed source 25. For example, the third matching circuit 260 further includes a capacitor 2602 located between the feed source 25 and the feed point 230. In other words, the capacitor 2602 is disposed on the feed path between the feed source 25 and the feed point 230.

In some embodiments, still refer to FIG. 38. A fourth matching circuit 410 that is grounded may be disposed at the port 41 of the third radiator 4. The fourth matching circuit 410 is configured to serve the first antenna structure. Specifically, the fourth matching circuit 410 is configured to match the third radiator 4 to the operating frequency of the first antenna structure. In this way, the third radiator 4 may be used as a part of the first antenna structure to operate in an operating frequency band of the first antenna structure, so that the third radiator 4, the first radiator 21, and the second radiator 22 operate as a whole, to reduce impact of the third radiator 4 on the first antenna structure as much as possible.

For example, the fourth matching circuit 410 includes a capacitor 4101 grounded, one end of the capacitor 4101 is electrically connected to the third radiator 4 at the port 41, and the other end of the capacitor 4101 is grounded.

It should be noted that the port 41 not only may be matched to the fourth matching circuit 410 to serve the first antenna structure, but also may be used as a feed point of the second antenna structure to be electrically connected to a feed source and/or a matching circuit, to serve the second antenna structure. Therefore, during implementation, a switch may be disposed at the port 41, and switching is performed between different paths by using the switch, to achieve different objectives.

In some embodiments, still refer to FIG. 38. A fifth matching circuit 510 that is grounded may be disposed at the port 51 of the fourth radiator 5. The fifth matching circuit 510 is configured to serve the first antenna structure. Specifically, the fifth matching circuit 510 is configured to match the fourth radiator 5 to the operating frequency of the first antenna structure. In this way, the fourth radiator 5 may be used as a part of the first antenna structure to operate in an operating frequency band of the first antenna structure, so that the fourth radiator 5, the first radiator 21, and the second radiator 22 operate as a whole, to reduce impact of the fourth radiator 5 on the first antenna structure as much as possible.

For example, the fifth matching circuit 510 includes a capacitor 5101 grounded, one end of the capacitor 5101 is electrically connected to the fourth radiator 5 at the port 51, and the other end of the capacitor 5101 is grounded.

It should be noted that the port 51 not only may be matched to the fifth matching circuit 510 to serve the first antenna structure, but also may be used as a feed point of the third antenna structure to be electrically connected to a feed source and/or a matching circuit, to serve the third antenna structure. Therefore, during implementation, a switch may be disposed at the port 51, and switching is performed between different paths by using the switch, to achieve different objectives.

In a specific example, the feed point 230 is disposed at the first end 221 of the second radiator 22, the first matching circuit 261 that is grounded is disposed at the first port 231 of the first radiator 21, the second matching circuit 262 that is grounded is disposed at the second port 232 of the first radiator 21, the third matching circuit 260 is disposed at the feed point 230 of the second radiator 22, the fourth matching circuit 410 that is grounded is disposed at the port 41 of the third radiator 4, and the fifth matching circuit 410 that is grounded is disposed at the port 51 of the fourth radiator 5. The first matching circuit 261 includes the capacitor 2612, one end of the capacitor 2612 is electrically connected to the first radiator 21 at the first port 231, and the other end of the capacitor 2612 is grounded. The second matching circuit includes the inductor 2622, one end of the inductor 2622 is electrically connected to the first radiator 21 at the second port 232, and the other end of the inductor 2622 is grounded. The third matching circuit 260 includes the inductor 2603 that is grounded and the capacitor 2602 located between the feed point 25 and the feed point 230. The inductor 2603 is connected in parallel to the feed path between the feed point 230 and the feed point 25. The fourth matching circuit 410 includes the capacitor 4101 that is grounded, one end of the capacitor 4101 is electrically connected to the third radiator 4 at the port 41, and the other end of the capacitor 4101 is grounded. The fifth matching circuit 510 includes the capacitor 5101 that is grounded, one end of the capacitor 5101 is electrically connected to the fourth radiator 5 at the port 51, and the other end of the capacitor 5101 is grounded. In such a structural design, when the second antenna structure and the third antenna structure are disposed on both sides of the first radiator 21, formation of the left-handed circularly polarized wave of the first antenna structure is facilitated while operating requirements of the second antenna structure and the third antenna structure are met.

In embodiments of this application, a switch may be disposed at each port or feed point of each radiator, and the switch is configured for switching between a plurality of matching circuits, to adjust the first antenna structure to different operating frequencies or to different states of other parameters. Disposition of the switch is similar to the design in FIG. 19 above. Refer to the foregoing design. Details are not described herein again.

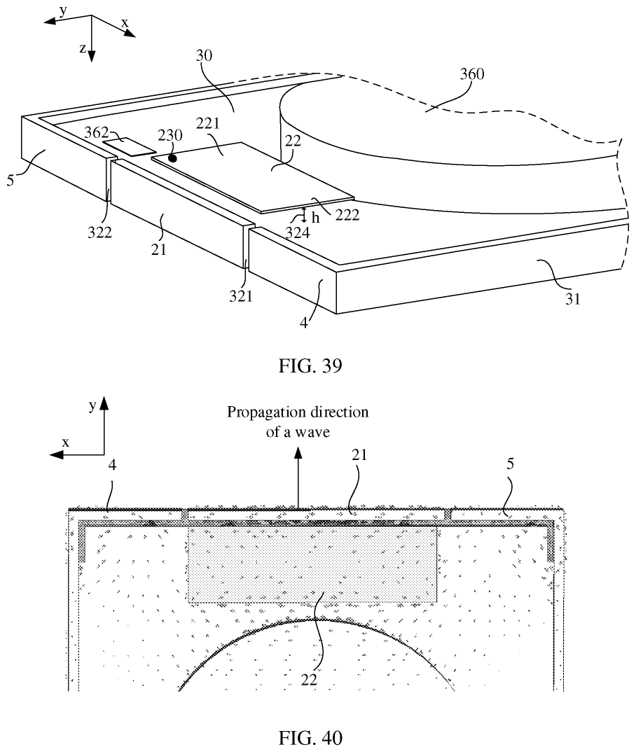

FIG. 39 is another three-dimensional schematic diagram of a local region near a first antenna structure in an electronic device according to an embodiment of this application. Compared with FIG. 35, in FIG. 39, a rear camera 360 is added, the first antenna structure is disposed on a side of the rear camera 360, and the second radiator 22 is disposed between the first radiator 21 and the rear camera 360.

When performing simulation on performance of the first antenna structure, due to close proximity of the rear camera 360 to the second radiator 22, the electronic device shown in FIG. 39 is used an example to conduct the simulation on the performance of the first antenna structure to obtain a relatively accurate simulation result for the first antenna structure. In addition, because the electronic component 362 affects the electrical length of the second radiator 22, for convenience of simulation, after the electrical length of the second radiator 22 is determined, the electronic component 362 is removed for simulation. In addition, the feed point 230 is disposed at the first end 221 of the second radiator 22, and left-handed circular polarization performance of the first antenna structure is focused.

With reference to FIG. 40 to FIG. 44, the following further describes results of left-handed circular polarization performance of the first antenna structure through simulation results according to embodiments of this application.

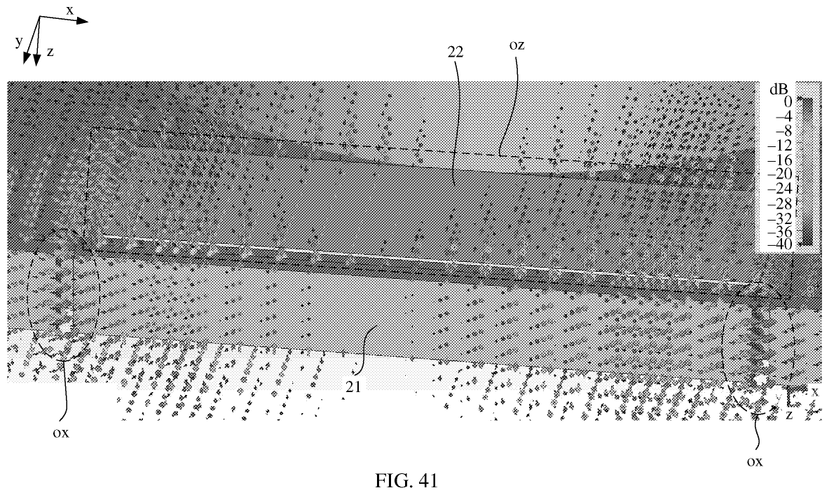

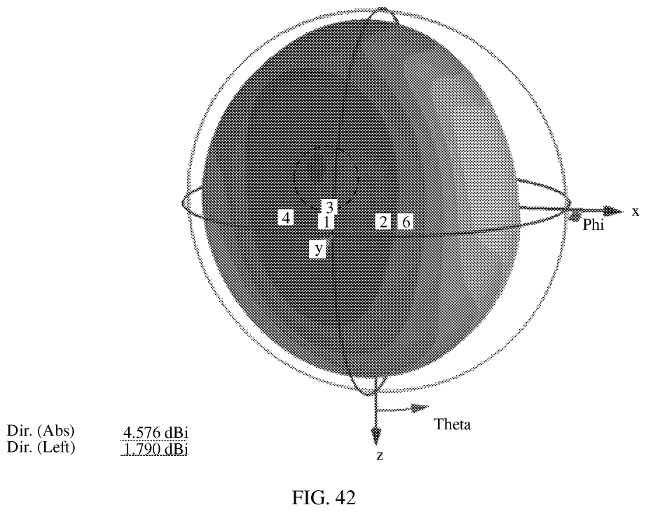

FIG. 40 to FIG. 42 are diagrams showing a simulation result of a first antenna structure when an operating frequency of the first antenna structure is 2.2 Ghz. FIG. 40 is a current distribution diagram of a local region near a first antenna structure in the electronic device shown in FIG. 39, when an operating frequency of the first antenna structure is 2.2 Ghz. FIG. 41 is a distribution diagram of an electric field in a local region near a first antenna structure in the electronic device shown in FIG. 39, when an operating frequency of the first antenna structure is 2.2 Ghz. FIG. 42 is a diagram of left-handed circular polarization directivity of the electronic device shown in FIG. 39 when an operating frequency of the first antenna structure is 2.2 Ghz.

In the 2.2 Ghz simulation structure of the first antenna structure shown in FIG. 39, in a specific example, a physical length of the first radiator 21 is 37 mm, a physical length of the second radiator 22 is 33 mm, except for the second gap 324, remaining gaps are basically 1.2 mm, and the second gap 324 is 1 mm. A matching circuit of each radiator is shown in FIG. 38. A capacitance value of the capacitor 2612 is 0.2 pF, an induction value of the inductor 2622 is 7.8 nH, a capacitance value of the capacitor 2602 is 1.5 pF, an induction value of the inductor 2603 is 7 nH, a capacitance value of the capacitor 4101 is 1.2 pF, and a capacitance value of the capacitor 5101 is 1.2 pF.

In FIG. 40, on a top end of the positive y-direction of the electronic device, current is distributed on both the first radiator 211 and the second radiator 22, and the first antenna structure generates radiation.

In FIG. 41, for an electromagnetic wave generated by the first antenna structure and whose propagation direction is the positive y-direction, an electric field component (shown in a dashed region ox) distributed along the x-direction and an electric field component (shown in a dashed region oz) distributed along the z-direction are formed. With regard to the electric field component in the z-direction that is focused on, it can be learned that, the electric field component distributed along the z-direction is formed between the second radiator 22 and the ground plane 30, and the entire second radiator 22 provides a large quantity of electric field components distributed along the z-direction.

General directivity and left-handed circular polarization directivity of the electronic device are displayed in the diagram of the left-handed circular polarization directivity in FIG. 42. For left-handed circular polarization directivity of a directional range (a region marked by a dashed circle) that is focused on and that is for receiving and sending a left-handed circularly polarized wave, a direction in which the left-handed circular polarization directivity of the electronic device is located is in the region marked by the dashed circle. Therefore, the left-handed circular polarization directivity of the electronic device shown in FIG. 42 may be used as the left-handed circular polarization directivity of the directional range that is focused on and marked by the dashed circle and that is for receiving and sending the left-handed circularly polarized wave. Based on this, the left-handed circular polarization directivity of the first antenna structure obtained in the simulation result in FIG. 42 is 1.79 dBi. Compared with FIG. 7, the left-handed circular polarization directivity can be improved by approximately 0.8 dBi than the existing technology, and the left-handed circularly polarized wave can be formed well, thereby effectively improving the circular polarization performance of the first antenna structure.

The result in FIG. 42 is further compared with the result in FIG. 23. In FIG. 23, the total polarization directivity of the first antenna structure is 3.786 dBi, the left-handed circular polarization directivity is 1.849 dBi, and the axial ratio is 18.1 dB. In FIG. 42, total polarization directivity of the first antenna structure is 4.576 dBi, the left-handed circular polarization directivity is 1.79 dBi, and an axial ratio is 29.82 dB. Compared with FIG. 23, although the axial ratio in FIG. 42 is not better than the axial ratio in FIG. 23, the total polarization directivity in FIG. 42 is increased. Even when the axial ratio is not optimal, the increase in the total polarization directivity ensures that the allocated left-handed circular polarization directivity remains reasonably good, and a final result is that the left-handed circular polarization directivity is still greatly improved.

Further, compared with FIG. 23, in FIG. 42, from a perspective of a size, the physical length of the first radiator 21 of the first antenna structure is increased by 5 mm. Although the physical length of the second radiator 22 is less than the physical length of the first radiator 21, the overall physical length of the second radiator 22 is increased by 1 mm, which generally enhances the electric field component in the x-direction. The second gap 324 between the second radiator 22 and the ground plane 30 is reduced by 1 mm, which generally reduces the electric field component in the z-direction. Therefore, an axial ratio of an electromagnetic wave radiated by the first antenna structure is reduced. However, the increase in the physical lengths of the first radiator 21 and the second radiator 22 leads to an increase in the total polarization directivity of the first antenna structure. Therefore, comprehensively, the left-handed circular polarization directivity of the first antenna structure that is finally obtained is still greatly improved compared with the existing technology.

In the 2.0 Ghz simulation structure of the first antenna structure shown in FIG. 39, the size of the antenna structure remains unchanged, and a matching circuit is slightly changed. A matching circuit of each radiator is similar to that in FIG. 38, where a capacitance value of the capacitor 2612 is 0.8 pF, the inductor 2622, the capacitor 2602, and the inductor 2603 are all open-circuited, a capacitance value of the capacitor 4101 is 1.2 pF, and a capacitance value of the capacitor 5101 is 1.2 pF.

Because phenomena of current distribution and electric field distribution when the operating frequency of the first antenna structure is 2.0 Ghz are basically similar to those of current distribution and electric field distribution when the operating frequency of the antenna structure is 2.2 Ghz, the current distribution and the electric field distribution when the operating frequency is 2.0 Ghz are not described herein again. For details, refer to related descriptions provided when the operating frequency of the antenna structure is 2.2 Ghz.

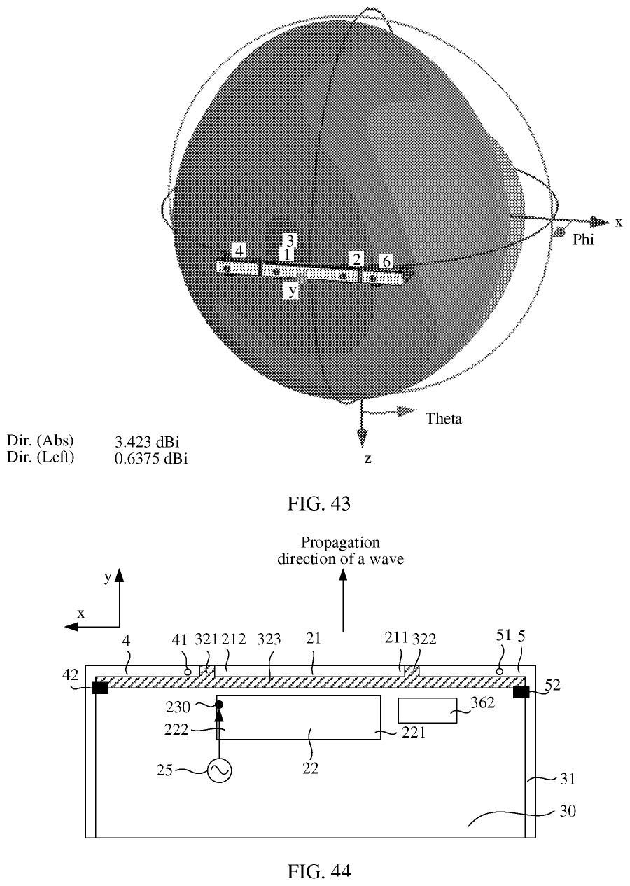

FIG. 43 is a diagram of left-handed circular polarization directivity of the electronic device shown in FIG. 39 when an operating frequency of the first antenna structure is 2.0 Ghz. In FIG. 43, it may be learned that the left-handed circular polarization directivity of the first antenna structure is 0.6375 dBi.

With reference to FIG. 44 to FIG. 52, the first antenna structure in embodiments of this application is described below from a perspective of improving the right-handed circular polarization performance. A main difference between the first antenna structure used for improving the right-handed circular polarization performance and the foregoing first antenna structure used for improving the left-handed circular polarization performance lies in disposition of a feed point and disposition of a related matching circuit. Remaining structures are basically similar. Therefore, only the difference between the two is described emphatically below. For descriptions of the similar structures, refer to the foregoing related descriptions.

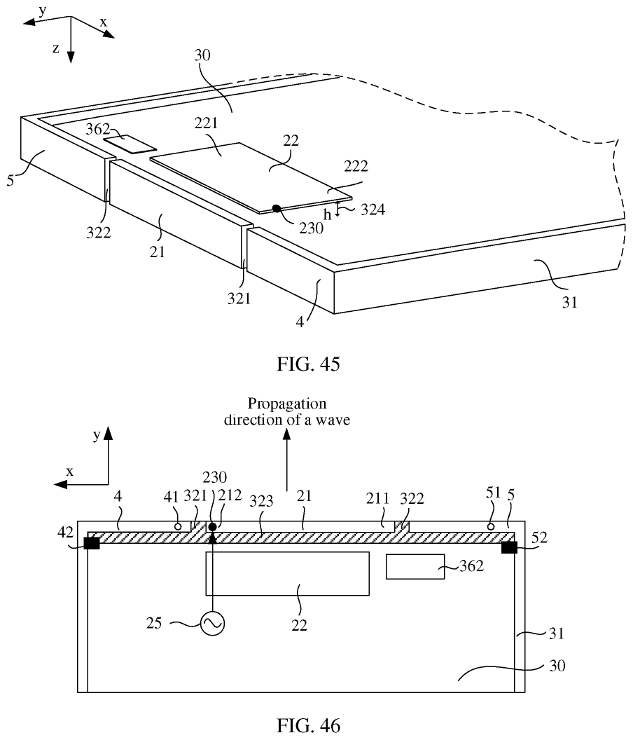

FIG. 44 is another schematic diagram of a local region near a first antenna structure in an electronic device according to an embodiment of this application. FIG. 45 is another three-dimensional schematic diagram of a local region near a first antenna structure in an electronic device according to an embodiment of this application. FIG. 46 is another schematic diagram of a local region near a first antenna structure in an electronic device according to an embodiment of this application.

In some embodiments, refer to FIG. 44 and FIG. 45. The feed point 230 is disposed on the second radiator 22. The second radiator 22 has two end portions: a first end 221 and a second end 222, distributed along the first direction (for example, the x-direction). For example, the feed point 230 is disposed at the second end 222 of the second radiator 22, that is, the feed point 230 is disposed at an end portion, located in a positive x-direction, of the second radiator 22. Such a disposing manner is beneficial to forming a right-handed circularly polarized wave.

In some other embodiments, refer to FIG. 46. The feed point 230 is disposed on the first radiator 21. The first radiator 21 has two end portions: a first end 211 and a second end 212, distributed along the first direction (for example, the x-direction). For example, the feed point 230 is disposed at the second end 212 of the first radiator 21, that is, the feed point 230 is disposed at an end portion, located in a positive x-direction, of the first radiator 21. Such a disposing manner is beneficial to forming a right-handed circularly polarized electromagnetic wave.

In some embodiments, still refer to FIG. 44 and FIG. 45. The electronic device further includes a second antenna structure, and the second antenna structure includes a third radiator 4.

In some embodiments, still refer to FIG. 44 and FIG. 45. The electronic device further includes a third antenna structure. The third antenna structure includes a fourth radiator 5, and a port 51 and a grounding point 52 are disposed on the fourth radiator 5.

In some embodiments, still refer to FIG. 44 and FIG. 45. The electronic device further includes an electronic component 362.

For descriptions of the second antenna structure, the third antenna structure, and the electronic component 362, refer to the related descriptions above. Details are not described again.

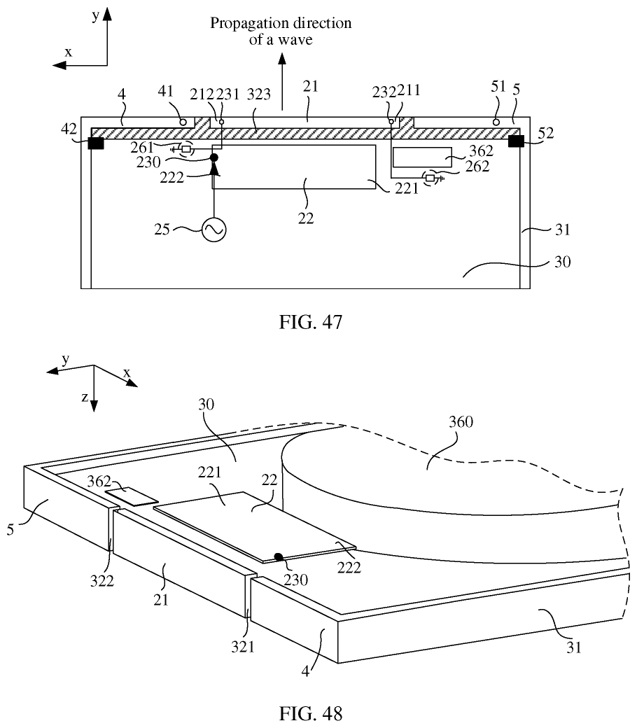

FIG. 47 is another schematic diagram of a local region near a first antenna structure in an electronic device according to an embodiment of this application.

In some embodiments, the second end 222 of the second radiator 22 is provided with the feed point 230. A matching circuit that is grounded is disposed on the first radiator 21, and the matching circuit is configured to match an operating frequency of the first antenna structure, and may further be configured to control a right-handed circularly polarized component of the antenna structure.

In some embodiments, refer to FIG. 47. The first radiator 21 includes two ports: a first port 231 and a second port 232. The first port 231 is located at the second end 212 of the first radiator 21, and the second port 232 is located at the first end 211 of the first radiator 21. A first matching circuit 261 that is grounded is disposed at the first port 231. A second matching circuit 262 that is grounded is disposed at the second port 232. The first matching circuit 261 and the second matching circuit 262 are configured to match the operating frequency of the first antenna structure, and may further be configured to control the right-handed circularly polarized component of the first antenna structure. Herein, the first port 231 and the feed point 230 are disposed on a same side of the first antenna structure.

In some embodiments, a third matching circuit 260 (shown in FIG. 38) may be disposed at the feed point 230, to match the operating frequency of the first antenna structure.

In some embodiments, still refer to FIG. 47. A fourth matching circuit 410 that is grounded may be disposed at the port 41 of the third radiator 4. The fourth matching circuit 410 is configured to serve the first antenna structure. Specifically, the fourth matching circuit 410 is configured to match the third radiator 4 to the operating frequency of the first antenna structure.

In some embodiments, still refer to FIG. 47. A fifth matching circuit 510 that is grounded may be disposed at the port 51 of the fourth radiator 5. The fifth matching circuit 510 is configured to serve the first antenna structure. Specifically, the fifth matching circuit 510 is configured to match the fourth radiator 5 to the operating frequency of the first antenna structure.

For related descriptions about the first matching circuit 261, the second matching circuit 262, the third matching circuit 260, the fourth matching circuit 410, and the fifth matching circuit 510, refer to the related descriptions about FIG. 38 above. Details are not described again.

When the feed point 230 is disposed at the second end 212 of the first radiator 21, for designs of matching circuits of the first radiator 21 and the second radiator 22, refer to the foregoing matching circuits. Details are not described again. Ports and matching circuits of the third radiator 4 and the fourth radiator 5 are still shown in FIG. 47.

It can be learned that, relative to the first antenna structure configured to improve the left-handed circular polarization performance, locations of the feed point 230, the first port 231, and the second port 232 of the first antenna structure configured to improve the right-handed circular polarization performance, and the first matching circuit 261 at the first port 231, the second matching circuit 261 at the second port 232, and the third matching circuit 260 at the feed point are all switched in a mirror manner, so that right-handed circular polarization of the first antenna structure can be implemented.

With reference to FIG. 48 to FIG. 52, the following further describes right-handed circular polarization performance of the first antenna structure through simulation results according to embodiments of this application.

FIG. 48 is another three-dimensional schematic diagram of a local region near a first antenna structure in an electronic device according to an embodiment of this application. In FIG. 48, the first antenna structure is disposed on a side of the rear camera 360, and the second radiator 22 is disposed between the first radiator 21 and the rear camera 360.

When performing simulation on performance of the first antenna structure, due to close proximity of the rear camera 360 to the second radiator 22, the electronic device shown in FIG. 48 is used an example to conduct the simulation on the performance of the first antenna structure to obtain a relatively accurate simulation result for the first antenna structure. In addition, because the electronic component 362 affects the electrical length of the second radiator 22, for convenience of simulation, after the electrical length of the second radiator 22 is determined, the electronic component 362 is removed for simulation. In addition, the feed point 230 is disposed at the second end 222 of the second radiator 22, and right-handed circular polarization performance of the first antenna structure is focused.

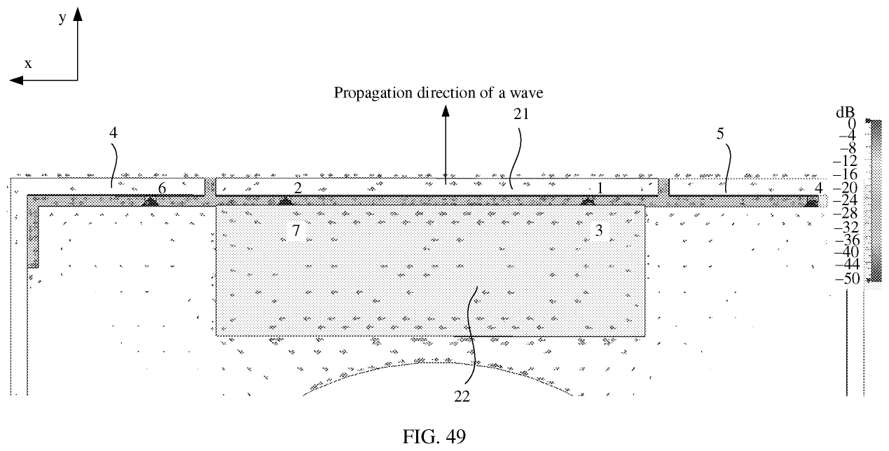

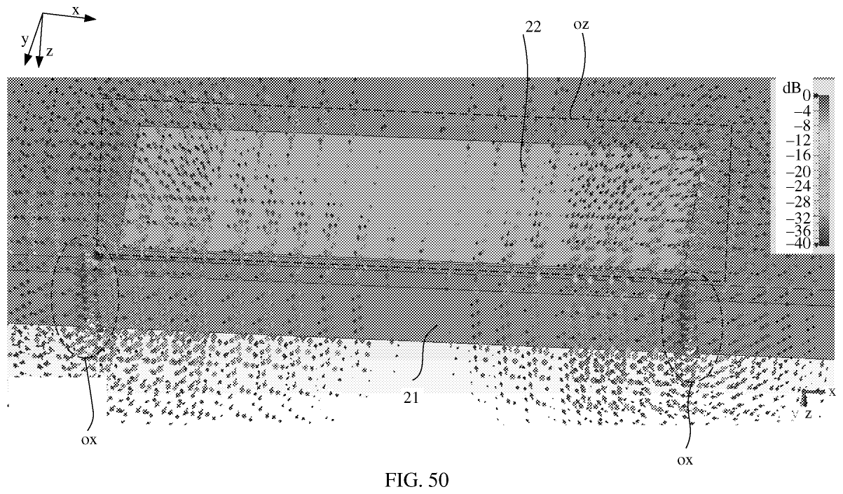

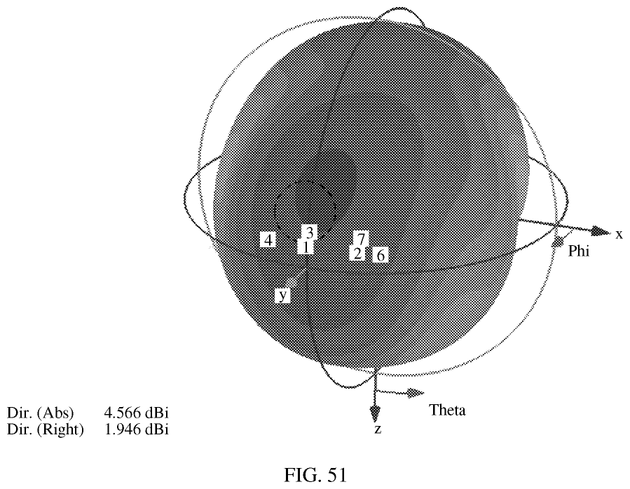

FIG. 49 to FIG. 51 are diagrams showing a simulation result of a first antenna structure when an operating frequency of the first antenna structure is 2.2 Ghz. FIG. 49 is a current distribution diagram of a local region near a first antenna structure in the electronic device shown in FIG. 48, when an operating frequency of the first antenna structure is 2.2 Ghz. FIG. 50 is a distribution diagram of an electric field in a local region near a first antenna structure in the electronic device shown in FIG. 49, when an operating frequency of the first antenna structure is 2.2 Ghz. FIG. 51 is a diagram of right-handed circular polarization directivity of the electronic device shown in FIG. 49 when an operating frequency of the first antenna structure is 2.2 Ghz.

In the 2.2 Ghz simulation structure of the first antenna structure shown in FIG. 48, in a specific example, a physical length of the first radiator 21 is 37 mm, a physical length of the second radiator 22 is 33 mm, except for the second gap 324, remaining gaps are basically 1.2 mm, and the second gap 324 is 1 mm. A matching circuit of each radiator is shown in FIG. 38. A capacitance value of the capacitor 2612 is 0.2 pF, an induction value of the inductor 2622 is 7.8 nH, a capacitance value of the capacitor 2602 is 1.5 pF, an induction value of the inductor 2603 is 7 nH, a capacitance value of the capacitor 4101 is 1.2 pF, and a capacitance value of the capacitor 5101 is 1.2 pF.

In FIG. 49, on a top end of the positive y-direction of the electronic device, current is distributed on both the first radiator 211 and the second radiator 22, and the antenna structure generates radiation.

In FIG. 50, for an electromagnetic wave generated by the first antenna structure and whose propagation direction is the positive y-direction, an electric field component (shown in a dashed region ox) distributed along the x-direction and an electric field component (shown in a dashed region oz) distributed along the z-direction are formed. With regard to the electric field component in the z-direction that is focused on, it can be learned that, the electric field component distributed along the z-direction is formed between the second radiator 22 and the ground plane 30, and the entire second radiator 22 provides a large quantity of electric field components distributed along the z-direction.

In FIG. 51, it may be learned that the right-handed circular polarization directivity of the first antenna structure is 1.946 dBi.

In the 2.0 Ghz simulation structure of the first antenna structure shown in FIG. 48, the size of the first antenna structure remains unchanged, and a matching circuit is slightly changed. A matching circuit of each radiator is similar to that in FIG. 38, where a capacitance value of the capacitor 2612 is 0.8 pF, the inductor 2622, the capacitor 2602, and the inductor 2603 are all open-circuited, a capacitance value of the capacitor 4101 is 1.2 pF, and a capacitance value of the capacitor 5101 is 1.2 pF.

Because phenomena of current distribution and electric field distribution when the operating frequency of the first antenna structure is 2.0 Ghz are basically similar to those of current distribution and electric field distribution when the operating frequency of the first antenna structure is 2.2 Ghz, the current distribution and the electric field distribution when the operating frequency is 2.0 Ghz are not described herein again. For details, refer to related descriptions provided when the operating frequency of the first antenna structure is 2.2 Ghz.

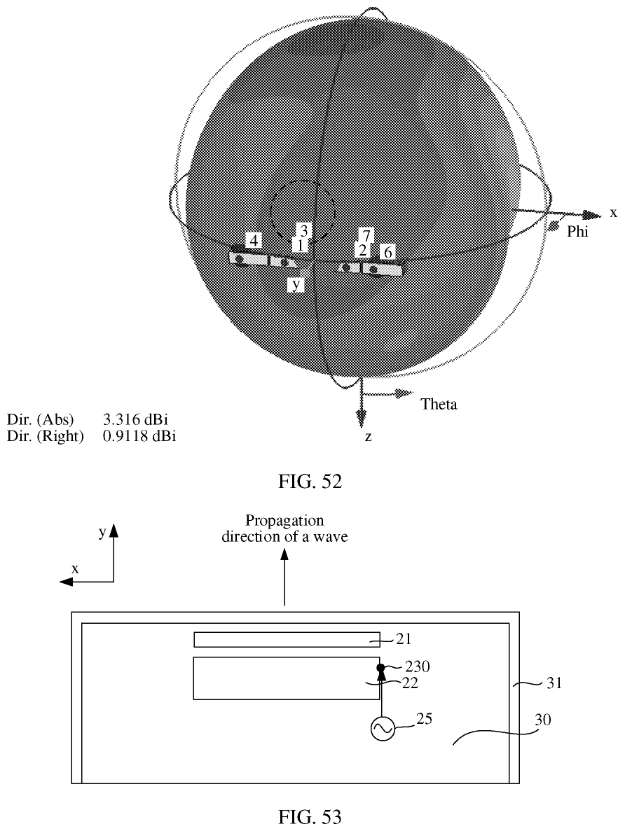

FIG. 52 is a diagram of right-handed circular polarization directivity of the electronic device shown in FIG. 49 when an operating frequency of the first antenna structure is 2.0 Ghz. In FIG. 52, it may be learned that the right-handed circular polarization directivity of the first antenna structure is 0.9118 dBi.

FIG. 53 is still another schematic diagram of a local region near a first antenna structure in an electronic device according to an embodiment of this application. Compared with the foregoing structure, a difference in the structure shown in FIG. 53 lies in that the first radiator 21 is disposed above and parallel to the ground plane 30, and the first gap 323 between the first radiator 21 and the ground plane 30 may be referred to as an operating height of the first radiator 21 relative to the ground plane 30. This structure may further enable the first antenna structure to form a circularly polarized wave.

To better improve the circular polarization performance of the first antenna structure, for example, still refer to FIG. 53. A size of the second radiator 22 in the third direction (for example, the y-direction) is greater than a size of the first radiator 21 in the third direction (for example, the y-direction). In other words, in the structure in which the first radiator 21 is disposed above and parallel to the ground plane 30, the first radiator 21 is closer to an elongated structure compared with the second radiator 22.

It may be understood that, in the structure in which the first radiator 21 and the second radiator 22 are disposed on and parallel to the ground plane 30, the first radiator 21 provides linear current in the first direction (for example, the x-direction), the second radiator 22 provides an electric field component distributed along the second direction (for example, the z-direction), and the second radiator 22 may operate in a patch mode. In this case, the second radiator 22 in the third direction (for example, the y-direction) needs to have a large size. Therefore, the size of the second radiator 22 in the third direction (for example, the y-direction) is greater than the size of the first radiator 21 in the third direction (for example, the y-direction). In this way, the second radiator 22 can provide a large quantity of electric field components distributed along the second direction (for example, the z-direction), thereby improving the circular polarization performance of the first antenna structure.

The foregoing descriptions are merely specific implementations of this application, but are not intended to limit the protection scope of this application. Any variation or replacement readily figured out by persons skilled in the art within the technical scope disclosed in this application shall fall within the protection scope of this application. Therefore, the protection scope of this application shall be subject to the protection scope of the claims. In conclusion, the foregoing embodiments are merely preferred embodiments of the technical solutions of this application, and are not used to limit the protection scope of this application. Any modification, equivalent substitution, improvement, and the like made within the spirit and the principle of this application shall be included in the protection scope of this application.

What is claimed is:

1. An electronic device, comprising a ground plane and a first antenna structure, wherein the first antenna structure comprises a first radiator and a second radiator, wherein
the first radiator is disposed on a side of the ground plane, and a first gap is spaced between the first radiator and the ground plane;
the second radiator is disposed above and parallel to the ground plane, and a second gap is spaced between the second radiator and the ground plane;
the first radiator and the second radiator are mutually non-contacting; and
at least one of the first radiator and the second radiator is provided with a feed point, wherein when feeding is performed at the feed point, the first radiator and the second radiator operate at a same operating frequency, and the first antenna structure is capable of generating an electric field component distributed along a first direction and an electric field component distributed along a second direction, wherein the first direction is perpendicular to the second direction, the first direction is parallel to a length direction of the first radiator, and the second direction is perpendicular to a plane in which the ground plane is located.

2. The electronic device according to claim 1, wherein one of the first radiator and the second radiator is provided with the feed point.

3. The electronic device according to claim 2, wherein the feed point is disposed in proximity to the other radiator that is not provided with a feed point.

4. The electronic device according to claim 2, wherein one end, distributed along the first direction, of one of the first radiator and the second radiator is provided with the feed point.

5. The electronic device according to claim 2, wherein the second radiator is provided with the feed point.

6. The electronic device according to claim 5, wherein a matching circuit that is grounded is disposed on the first radiator, and the matching circuit is configured to match an operating frequency of the first antenna structure.

7. The electronic device according to claim 6, wherein a first port is disposed at one end, distributed along the first direction, of the first radiator; the matching circuit comprises a first matching circuit that is grounded; the first matching circuit is disposed at the first port; the first port and the feed point are located on a same side of the first antenna structure; and the first matching circuit comprises a capacitor.

8. The electronic device according to claim 7, wherein a second port is disposed at the other end, distributed along the first direction, of the first radiator; the matching circuit further comprises a second matching circuit that is grounded; the second matching circuit is disposed at the second port; and the second matching circuit comprises an inductor.

9. The electronic device according to claim 1, wherein a third matching circuit is disposed at the feed point, and the third matching circuit is configured to match the operating frequency of the first antenna structure.

10. The electronic device according to claim 1, wherein the first radiator is capable of generating the electric field component distributed along the first direction, and the second radiator is capable of generating the electric field component distributed along the second direction.

11. The electronic device according to claim 1, wherein an electrical length of the second radiator along the first direction and an electrical length of the first radiator along the first direction are both between a one-quarter wavelength and a one-half wavelength, wherein the wavelength is an operating wavelength of the first antenna structure.

12. The electronic device according to claim 11, wherein projections of the first radiator and the second radiator on a plane formed by the first direction and the second direction at least partially overlap.

13. The electronic device according to claim 1, wherein the electronic device comprises a bezel, the bezel surrounds the ground plane, and the first radiator is a part of the bezel.

14. The electronic device according to claim 1, wherein the second radiator is formed as a sheet-like structure.

15. The electronic device according to claim 1, wherein the first antenna structure further comprises an antenna holder, the second radiator is disposed on the antenna holder, and the antenna holder is disposed on the ground plane.

16. The electronic device according to claim 1, wherein the first gap is less than or equal to 2 mm, and/or the second gap is less than or equal to 3 mm.

17. The electronic device according to claim 1, wherein the first antenna structure is disposed at a top end of the electronic device.

18. The electronic device according to claim 17, wherein a rear camera is disposed at the top end of the electronic device, and the second radiator is disposed between the first radiator and the rear camera.

19. The electronic device according to claim 1, wherein the ground plane is a printed circuit board or a mid-frame in the electronic device.

20. The electronic device according to claim 1, wherein the first antenna structure is configured for satellite communication.
